(19) United States
(12) Patent Application Publication
(10) Pub. No.: US 2024/0186551 A1
(43) Pub. Date: Jun. 6, 2024

(54) FUEL CELL DEVICE

(71) Applicant: Stefan Dwenger, Reutlingen (DE)

(72) Inventor: Stefan Dwenger, Reutlingen (DE)

(73) Assignees: EKPO Fuel Cell Technologies GmbH, Dettingen (DE); Spörl KG Präzisionsdrahtweberei, Sigmaringendorf (DE)

(21) Appl. No.: 18/440,617

(22) Filed: Feb. 13, 2024

Related U.S. Application Data
(63) Continuation of application No. PCT/EP2022/071656, filed on Aug. 2, 2022.

(30) Foreign Application Priority Data
Aug. 16, 2021 (DE) 10 2021 121 268.5

(51) Int. Cl. H01M 8/0662; B60L 58/33; B60L 58/34; H01M 8/04029; H01M 8/04082

(52) U.S. Cl. CPC H01M 8/0687; B60L 58/33; B60L 58/34; H01M 8/04029; H01M 8/04201; H01M 2250/20

(57) ABSTRACT

In order to improve a fuel cell device comprising at least one fuel cell unit and a conduit arrangement, in particular for a fuel medium and/or for an oxidation medium and/or for a temperature-control medium, it is proposed to arrange in the conduit arrangement, in particular in a conduit portion thereof, a combined component forming a heat exchanger and a fluid modifier that forms in particular a separator.

### CROSS-REFERENCE TO RELATED PATENT APPLICATION

This application is a continuation of international application number PCT/EP2022/071656 filed on Aug. 2, 2022, and claims the benefit of German application No. DE 10 2021 121 268.5 filed on Aug. 16, 2021.

This patent application relates to the subject matter disclosed in and claims the benefit of international application PCT/EP2022/071656 filed on Aug. 2, 2022, and German application No. DE 10 2021 121 268.5 filed on Aug. 16, 2021, the teachings and disclosure of which are hereby incorporated in their entirety by reference thereto for all purposes.

### BACKGROUND OF THE INVENTION

The invention relates to a fuel cell device which comprises at least one fuel cell unit, and to a vehicle which is at least partially driven by means of at least one fuel cell unit of a fuel cell device.

### SUMMARY OF THE INVENTION

The object of the invention is to improve a fuel cell device and/or a vehicle driven at least partially by means of a fuel cell unit.

According to one aspect of the invention, this object is achieved by a fuel cell device which comprises at least one fuel cell unit and a conduit arrangement, wherein there is disposed in the conduit arrangement, in particular in a conduit portion of the conduit arrangement, a combined component forming a heat exchanger and a fluid modifier, wherein in particular the fluid modifier forms a separator.

In particular, the conduit arrangement, which for example comprises one conduit system or a plurality of conduit systems, is intended for a fuel medium and/or for an oxidation medium and/or for a temperature-control medium.

The conduit arrangement is expediently configured for supplying at least one medium to the at least one fuel cell unit and/or for discharging at least one medium from the fuel cell unit.

For example, one advantage of the invention is that the combined component is disposed in the conduit arrangement and thus a heat exchanger and a fluid modifier, in particular a separator, are formed in a space-saving manner in one component.

In particular, the combined component has a flow-through areal portion, through which a fluid mixture flowing through the conduit portion in which the combined component is disposed must flow.

In particular, by means of the combined component, the fluid mixture can thus be brought into a desired temperature range, in particular heated or cooled, and/or can be modified physically and/or chemically by the fluid modifier, preferably at least one constituent of the fluid or of the fluid mixture is at least partially separated and/or the fluid is mixed and/or at least one constituent is dispersed and for example droplets of a liquid phase are collected and/or at least size-reduced and/or in particular at least one constituent, in particular water, is transferred from a liquid phase into a gaseous phase by the combination of temperature control and modification, for example by vaporization above the boiling point and/or by evaporation below the boiling point.

The supplied and/or discharged fluid is hereby advantageously treated by the combined component, that is to say in particular temperature-controlled and/or modified, as explained above, and preferably increases the efficiency of the fuel cell device.

In particular, the combined component comprises a plurality of pipes, in particular hollow pipes, for a heat transfer medium that pass through the flow-through areal portion.

The pipes preferably comprise a flow-through interior, which is surrounded peripherally by a pipe wall and extends in a pipe extension direction, wherein in particular the heat transfer medium flows through the flow-through interior.

In particular the pipe wall separates the flow-through interior from the interior of the conduit portion through which the fluid mixture flows.

The pipes can have a wide variety of cross sections which in particular run at least approximately perpendicular to their respective pipe extension direction. For example, the cross section is at least partially round, for example oval or circular, and/or at least partially straight and/or angular, for example polygonal, in particular triangular or quadrangular or hexagonal, for example crescent-shaped.

For example, a heat transfer medium can expediently flow through the pipes and a fluid mixture flowing through the conduit portion flows around the pipes, so that a heat exchange can take place between the heat transfer medium and the fluid mixture.

It is provided here in some embodiments that, in particular depending on the operating state, the heat transfer medium flowing through the pipes emits heat and the fluid mixture flowing through the conduit portion and in particular flowing around the pipes is heated.

It is provided here in some embodiments that, in particular depending on the operating state, the heat transfer medium flowing through the pipes, for example a refrigerant, absorbs heat and cools the fluid mixture flowing through the conduit portion, in particular flowing around the pipes.

For example, the heat transfer medium comprises an alcohol, in particular glycol.

The heat transfer medium is expediently a mixture comprising an alcohol, in particular glycol, and/or water.

In particular, the plurality of pipes are part of a temperature-control circuit, by means of which the fluid mixture flowing through the conduit portion is temperature-controlled, in particular is brought to a desired temperature range, preferably is temperature-controlled at least approximately to a target temperature, for example is heated or cooled.

The modification is preferably assisted by the temperature control, for example the at least partial transfer of a constituent of the fluid mixture, in particular water, from a liquid phase into a gaseous phase is assisted by heating.

In particular, the plurality of pipes are connected to a reservoir space for the heat transfer medium, so that the heat transfer medium can flow from the reservoir space to and through the plurality of pipes and/or can flow from the pipes to the reservoir space, so that in particular a temperature-control circuit is formed.

The combined component advantageously has an inlet port connected to the pipes and an outlet port connected to the pipes.

A simple connection of the combined components into the temperature-control circuit is hereby expediently made possible by means of the inlet portion and the outlet port.

In particular, the plurality of pipes in respect of a fluid path in the pipe system are disposed between the inlet port and the outlet port, wherein the fluid path between the inlet port and the outlet port for example has a plurality of strands connected in parallel, which run through individual pipes from the plurality of pipes.

In particular, at least one inlet distributor conduit portion leads from the inlet port to an inlet end of a pipe, preferably to inlet ends of at least some pipes, for example to all inlet ends of the plurality of pipes. Heat transfer medium supplied via the one inlet port can thus advantageously be supplied to the pipes.

In particular, at least one outlet manifold portion leads from an outlet end of a pipe, preferably from at least some outlet ends, for example from all outlet ends, of the plurality of pipes to the outlet port. For example, heat transfer medium that has passed through the pipes can expediently be discharged via the one outlet port and in particular conducted onward in the temperature-control circuit.

The fuel cell device, in particular the temperature-control circuit, preferably comprises a temperature-control unit in order to bring the heat transfer medium to a temperature favorable for the temperature control of the fluid mixture, that is to say to bring it in particular to a temperature in order to cool or to heat the fluid mixture.

In particular, the pipes, in particular their pipe wall, are formed from a material that is a good heat conductor.

The pipes, in particular their pipe wall, are preferably formed from a metal material, for example from a steel, in particular stainless steel.

For example, an inner diameter of the pipes is at least 0.1 millimeters, preferably at least 0.2 millimeters.

In particular, an inner diameter of the pipes is at most ten millimeters, for example at most five millimeters, in particular at most three millimeters.

In particular, it is provided that the combined component has at least one modification material in a flow-through areal portion.

For at least partial forming of the separator, the modification material is advantageously disposed in the flow-through areal portion.

The fluid mixture flowing through the conduit portion advantageously flows against the modification material and the modification material modifies the fluid mixture in particular physically and/or chemically.

In some favorable embodiments the modification material is disposed in the flow-through areal portion such that the fluid mixture flows around it with a laminar flow and/or such that it homogenizes the flow of the fluid mixture.

It is advantageous that a pressure loss and/or flow resistance at the combined component is kept low.

In some preferred embodiments the modification material is disposed in the flow-through areal portion such that it induces a turbulent flow of the fluid mixture.

For example, it is advantageous that a heat exchange and/or a modification at the combined component is hereby increased.

The modification material advantageously modifies the fluid mixture flowing around by at least partial separation of at least one constituent of the fluid mixture, in particular a liquid phase, for example water. An undesirable constituent or at least parts thereof is thus advantageously removed from the fluid mixture.

For example, a liquid water input in at least one fuel cell unit, in particular a stack thereof, can thus be at least reduced or even prevented entirely.

In advantageous embodiments the modification material modifies the fluid mixture flowing around in such a way that at least one constituent, for example drops, of a liquid phase that exceed at least a permissible size are collected and/or size-reduced by the modification material and/or, for example assisted by heating by means of the heat exchanger, transition into the gaseous phase, so that for example water is dissolved in a gas of the fluid mixture.

For example, moisture in the fluid mixture can be maintained, in particular in order to prevent drying out of the at least one fuel cell unit, and at the same time excessively large drops, which may lead to damage in the fuel cell unit and/or to the formation of moisture films in the fuel cell unit, which may block a media exchange and/or may impair the functioning of the fuel cell unit and/or may reduce the performance and/or may lead to irregular operating conditions, are separated.

The modification material preferably comprises a material suitable for separating a liquid, in particular for separating water.

For example, the modification material comprises a hydrophilic material.

For example, the modification material comprises a metal material and in particular the modification material is a metal material.

For example, the metal material is a steel, in particular stainless steel.

It is preferably provided that the modification material is disposed at least partially in gaps between the pipes of the combined component.

For example, a fluid flowing through between the pipes thus impinges on the modification material and is thus modified thereby.

In particularly favorable embodiments it is provided that the modification material is disposed bearing at least partially against the pipes of the combined component.

It is preferably provided that the parts of the modification material disposed between the pipes and the parts of the modification material bearing against the pipes are connected to one another in particular by parts of the modification material.

By way of the modification material bearing against the pipes and in particular by way of the connection to the parts of the modification material disposed between the pipes, a surface for a heat exchange between the fluid mixture and the heat transfer medium is preferably significantly increased.

In particular, an advantageous solution is hereby provided in order to provide, in a space-saving manner, a large surface for a heat transfer between the heat transfer medium and the fluid mixture and/or for the modification of the fluid mixture.

In particularly advantageous embodiments it is provided that the modification material is disposed in at least one layer in the flow-through areal portion, in particular passes through the flow-through areal portion in at least one layer.

The modification material is thus provided over a large area.

In particular, the layer passes through the entire flow-through areal portion.

The layer preferably has a much smaller extent perpendicular to its large-area extent, for example an extent that is at least ten times smaller, for example at least 50 times smaller than in its areal extent.

In particular, the layer as geometric layer is defined by a geometric plane in such a way that the layer extends preferably over a large area along two areal directions spanning the geometric plane, which areal directions run in particular at least approximately perpendicular to one another, and the layer has a much smaller extent perpendicular to the geometric plane than in the plane, wherein in particular the much smaller extent is at least ten times smaller, for example at least 50 times smaller, than the extent of the layer in the geometric plane.

In particular, the much smaller extent is 20 mm or less, preferably 10 mm or less, for example 5 mm or less.

The large-area extent of the at least one layer, in particular the geometric plane, preferably runs in a curved manner through the flow-through areal portion, in particular with a plurality of curvatures at different points of the large-area extent.

It is particularly advantageous if some of the plurality of pipes are disposed on one side of the at least one layer and some of the plurality of pipes are disposed on an opposite side of the layer.

In particular, the large-area extent, in particular the geometric plane, is curved correspondingly, so that some of the plurality of pipes are disposed on one side and some of the plurality of pipes are disposed on the opposite side.

In some particularly advantageous embodiments the modification material is disposed in at least two layers in the flow-through areal portion.

At least some of the plurality of pipes are preferably disposed between the at least two layers.

In particular, the at least two layers intersect once or preferably multiple times.

The at least two layers advantageously intersect in a gap, preferably in a plurality of gaps, between the plurality of pipes.

The modification material can be disposed in a wide variety of ways in the layer and/or can form the layer.

For example, a film, in particular perforated film, provides the modification material at least partially and the film, in particular perforated film, is preferably formed from the modification material.

In particularly favorable embodiments fibers provide the modification material at least partially.

In particular the fibers pass through the flow-through areal portion.

At least some of the fibers preferably run in the at least one layer.

It is particularly advantageous if some of the fibers run in one of at least two layers and some of the fibers run in another of the at least two layers.

The at least two layers with fibers preferably intersect at least once.

At least some of the plurality of pipes are advantageously disposed between the at least two layers with fibers.

In particular, the layer of which the areal extent is defined along an elongate extent of the fibers is defined as geometric layer, and the extent of the layer perpendicular to the areal extent corresponds substantially to a diameter of the fibers.

The fibers passing in particular through the flow-through areal portion are preferably formed from the modification material.

In particular, the fibers are elongate bodies and in particular flexible bodies.

For example, the fibers are wires.

In particular, it is advantageous in the case of the fibers that these provide a large surface for the modification and/or a heat exchange and can be disposed in a space-saving manner in an interior of the conduit portion through which the fluid mixture flows.

With the fibers, a solution can be realized particularly favorably in which the modification material bears at least in part against the pipes and is disposed at least in part in the gaps between the pipes and advantageously provides a large surface which is connected to the pipes. In particular, a significant reduction of the installation space requirements for a heat exchanger and a fluid modifier in the conduit arrangement of the fuel cell device can be achieved hereby.

In expedient solutions a significant increase in the heat transfer rates in comparison to previously known heat exchangers, for example by at least a factor of 100, for example by at least a factor of 500, can be achieved.

In particularly advantageous embodiments it is provided that at least some of the fibers and at least some of the plurality of pipes in particular in the flow-through areal portion together form a woven fabric.

The woven fabric in the flow-through areal portion advantageously forms a large-area structure with a large surface and in particular fine-meshed flow-through openings, so that these interact particularly expediently with the fluid mixture flowing through for heat transfer and/or modification of the fluid mixture.

In particular, in the woven fabric the fibers also form a unit with the pipes, so that the fibers, by their arrangement bearing against the pipes and at the same time by their extension between the pipes, particularly favorably assist the heat transfer between the heat transfer medium flowing in the pipes and the fluid mixture flowing through the flow-through areal portion.

Alternatively or additionally, the above-described object is achieved by a fuel cell device which comprises at least one fuel cell unit and a conduit arrangement, in particular a conduit arrangement for a fuel medium and/or for an oxidation medium and/or for a temperature-control medium, wherein a combined component is disposed in the conduit arrangement, in particular in a conduit portion thereof, which combined component comprises precisely one functional layer or a plurality of functional layers preferably for heat transfer and/or modification of a fluid mixture flowing through.

In particular, at least one functional layer, preferably all functional layers, is configured both for heat transfer and for modification of the fluid mixture flowing through.

In particular, this likewise forms an installation-space-saving solution in order to control the temperature of and/or to modify a fluid mixture flowing through the conduit portion in which the combined component is disposed, in particular to modify it as above, for example to separate at least one constituent of the fluid mixture at least partially and/or to mix the fluid mixture at least partially and/or to disperse at least one liquid phase at least partially and/or to transfer it at least partially into a gaseous phase.

In particularly advantageous embodiments it is provided that the combined component with precisely one functional layer or a plurality of functional layers has one or advantageously a plurality of the above-explained features, and therefore reference is made fully to the above comments with regard to advantageous embodiments and advantages thereof.

The above-explained advantageous embodiments also preferably have one or more of the features explained below, and in particular it is provided here that the combined component comprises precisely one functional layer or a plurality of functional layers.

At least one functional layer, in particular all functional layers, advantageously has/have a plurality of pipes and/or modification material, in particular with one or more of the above-explained advantageous features.

In particular, the woven fabric forms at least some of the fibers and at least some of the pipes form a functional layer.

It is preferably provided that at least one layer with the modification material at least in one functional layer and/or at least in one flow-through areal portion runs alternately on different sides of the pipes in relation to a plane spanned by the pipe extension directions of the pipes.

In some advantageous embodiments it is provided that the fibers run transversely, for example at least approximately perpendicularly, to the pipes at least in one functional layer and/or in at least one flow-through areal portion.

It is expediently achieved here that the fibers, to assist the heat transfer, are preferably in contact with the pipes and also run in spaces between the pipes for modification of the fluid mixture flowing through.

It is particularly advantageous if the fibers at least in one functional layer and/or at least in one flow-through areal portion run alternately on different sides of the pipes in relation to a plane spanned by pipe extension directions of the pipes.

Good contact of the fibers with the pipes and for example a fine-meshed structure is preferably hereby achieved and has an advantageous effect on the heat transfer between the heat transfer medium and the fluid flowing through and/or on the modification of the fluid mixture.

In some favorable embodiments it is provided that at least some fibers, in particular in at least one layer, run adjacently to one another and preferably partially on one side and partially on the other side of the pipes in relation to the plane spanned by the pipe extension directions and thus the fibers extend at least partially between the pipes from one side to the other side.

In some advantageous embodiments the fibers of at least one functional layer and/or at least in one flow-through areal portion themselves form a woven fabric which extends in particular in the layer, and this woven fabric preferably runs partially on one side and partially on the other side of the pipes in relation to the plane spanned by the pipe extension directions.

At least one functional layer preferably runs obliquely to a fluid guidance direction in the conduit portion in which the combined component is disposed.

For example, at least one obliquely disposed functional layer runs at an angle of 5° or greater obliquely to the fluid guidance direction.

It is expedient if at least one obliquely disposed functional layer runs at an angle of 80° or less to the fluid guidance direction.

In some preferred embodiments the angle at which at least one obliquely disposed functional layer runs obliquely to the fluid guidance direction is at least 30°, preferably at least 40°, in particular at least 50°.

Larger angles for an improved heat transfer are advantageous here.

In some advantageous embodiments the angle at which at least one obliquely disposed functional layer runs obliquely to the fluid guidance direction is at most 50°, for example at most 35°, in particular at most 20°.

Smaller angles are advantageous here for a smaller pressure drop and/or for improved modification.

An areal portion of at least one functional layer which in particular forms the flow-through areal portion or at least part hereof is preferably larger than a cross-sectional area of an interior of the conduit portion in which the combined component is disposed, wherein the cross-sectional area is measured in a cross section running perpendicular to the fluid guidance direction.

For example, walls of the conduit portion delimiting the interior thereof run at least substantially in the direction of the fluid guidance direction.

In expedient embodiments the pipes run at least in one flow-through areal portion and/or at least in one functional layer in respective pipe extension directions which are oriented at least approximately in the same direction.

In particular the pipes are disposed adjacently in an arrangement direction in the flow-through areal portion and/or in at least one functional layer.

In particular the arrangement direction runs at least approximately perpendicularly to the direction in which the pipe extension directions run.

In some advantageous embodiments the arrangement direction runs obliquely to the fluid guidance direction.

In particular in an obliquely disposed functional layer the arrangement direction runs obliquely to the fluid guidance direction.

For example, the arrangement direction runs at an angle of 5° or greater and/or at an angle of 80° or smaller obliquely to the fluid guidance direction.

In some advantageous embodiments the arrangement direction runs at an angle of at least 30°, preferably at least 40°, for example at least 50° obliquely to the fluid guidance direction.

In some preferred embodiments the arrangement direction runs at an angle of at most 50°, for example at most 35°, in particular at most 20° obliquely to the fluid guidance direction.

In particularly advantageous embodiments it is provided that the pipes of a downstream functional layer are disposed in such a way that a fluid mixture that flows through gaps between pipes of an upstream functional layer flows against these pipes of the downstream functional layer. In particular, the two functional layers are functional layers disposed adjacently to one another.

For example, pipes of two functional layers, in particular adjacent functional layers, are disposed running obliquely to one another.

In some advantageous embodiments it is provided that the pipes of two functional layers, in particular of two functional layers disposed adjacently to one another, are disposed offset from one another, in particular offset from one another in their arrangement direction, and advantageously the pipes of a functional layer are disposed here adjacently to gaps between pipes of the other functional layer.

In particular, pipes of one functional layer are disposed relative to pipes of another, for example adjacently disposed functional layer in such a way that, in a projection of the one functional layer onto the other functional layer, the pipes of the one functional layer are projected at least in part onto gaps between the pipes of the other functional layer.

It is hereby advantageously achieved that a fluid mixture flowing through the functional layers flows through gaps between pipes of the one functional layer and flows against pipes of the other functional layer, and therefore a heat transfer between the fluid mixture and the heat transfer medium and/or the modification of the fluid mixture is improved.

In particular it is provided that the combined component has flow-through openings in at least one functional layer, in the case of a plurality of functional layers preferably in some, for example in all of the plurality of functional layers, and/or in the flow-through areal portion.

It is particularly advantageous if the flow-through openings at least in one functional layer and/or in at least one flow-through areal portion are surrounded at least in part by the modification material and/or the pipes.

In particular it is provided that the flow-through openings are delimited by the modification material and/or the pipes and preferably the flow-through openings are formed by the modification material and/or the pipes.

No further details have yet been made in respect of further forms of the combined component.

For example, the combined component comprises a frame.

In particular it is provided that at least one flow-through areal portion is surrounded by a frame, in particular is surrounded peripherally.

It is preferably provided that at least one functional layer comprises a frame, in particular that the frame is disposed peripherally in an outer region of the functional layer.

In some embodiments with a plurality of functional layers and/or flow-through areal portions it is provided that each of the functional layers and/or each flow-through areal portion comprises a respective frame.

In other expedient embodiments it is provided that the plurality of functional layers and/or the plurality of flow-through areal portions have a common frame which surrounds the flow-through areal portions and/or functional layers peripherally.

The frame is preferably secured to a conduit wall of the conduit portion and is advantageously connected fluid-sealingly to the conduit wall surrounding the interior of the conduit portion.

In particular the at least one flow-through areal portion and/or the at least one functional layer is thus connected to the conduit wall by means of the frame and is secured thereto, and a fluid mixture which flows through the conduit portion must flow through the at least one flow-through areal portion and/or through the at least one functional layer.

The frame can be formed from a wide variety of materials.

In some advantageous embodiments the frame is formed from a plastic.

For example, the frame is formed from an elastomer.

In some preferred embodiments the frame is formed from a metal material which in particular is resistant to corrosion.

In particular the pipes and/or the modification material are/is connected to the frame in particular in an integrally bonded and/or positive-locking manner and in particular is secured thereto, for example welded or soldered.

It is preferably provided that the pipes and/or the modification material, in particular the fibers providing the modification material, are embedded in the frame at least partially.

For example, the pipes and/or the modification material, in particular the fibers providing the modification material, are overmolded by the material of the frame, in particular a plastic.

In particular it is provided that at least some of the pipes run through the frame and thus for example can run on the one hand through the flow-through areal portion and with a further part running outside the conduit portion can be connected for example to a temperature-control circuit, in particular via the inlet port and/or outlet port, wherein the part running through the flow-through areal portion and the part of the pipes running outside the conduit portion are connected to one another by a part of the pipes running through the frame.

In some advantageous embodiment it is provided that the inlet port is formed on an inlet side of the frame and the inlet distributor conduit portion leading from the inlet port to an inlet end of a pipe or the plurality of inlet distributor conduit portions leading from the inlet port to respective inlet ends of at least some pipes is/are formed within the frame.

In particular it is provided that the outlet port is formed on an outlet side of the frame and advantageously the outlet manifold portion leading from an outlet end of a pipe to the outlet port or the plurality of outlet manifold portions leading at a respective outlet end of the pipes to the outlet port is/are formed within the frame.

In some preferred embodiments a manifold attachment having the inlet port is provided, in which manifold attachment the one inlet manifold portion or the plurality of inlet manifold portions are formed.

In particular the manifold attachment is connected to the frame in an integrally bonded and/or positive-locking manner and in particular is secured thereto.

The one inlet manifold portion is advantageously connected fluid-tightly to the inlet end of the pipes or the plurality of inlet manifold portions are advantageously connected fluid-tightly to the respective inlet end of at least some of the pipes, for example to a respective sealing element and/or to a sealing compound, which in particular is shapeable.

For example, the integrally bonded connection between the connector attachment and the frame is also established by means of the, in particular shapeable, sealing compound.

In particular a manifold attachment having the outlet port, in which manifold attachment the one outlet manifold portion or the plurality of outlet manifold portions is/are formed, is provided.

In particular the manifold attachment having the outlet port is connected to the frame in an integrally bonded and/or positive-locking manner and in particular is secured thereto.

The one outlet manifold portion is advantageously connected fluid-tightly to the one outlet end of the pipes or the plurality of outlet manifold portions are advantageously connected fluid-tightly to the respective outlet end of at least some of the pipes, in particular to a sealing element and/or to a sealing compound, which in particular is shapeable.

For example, the integral bond between the manifold attachment having the outlet port and the frame is also established by the, in particular shapeable, sealing compound.

In particularly advantageous embodiments it is provided that the combined component is formed as a module unit, in particular a pre-assembled module unit.

In particular the object underlying the invention is also achieved by a module unit which is configured for a fuel cell device and which forms a combined component forming a heat exchanger and a fluid modifier.

The module unit forming the combined component preferably comprises here one or preferably more of the above-explained features.

No further details have yet been provided in respect of further advantageous forms of the combined component formed as a module unit and/or of the module unit forming the combined component.

In particular the module unit is an assembly that cannot be dismantled without being destroyed.

The module unit preferably comprises the at least one flow-through areal portion and/or the at least one functional layer, that is to say in particular the pipes and the modification material, and advantageously the inlet port and the outlet port.

In advantageous embodiments the module unit comprises the frame and for example—if provided—the manifold attachment having the inlet port and the outlet port.

In particular the module unit has a joining portion, which is advantageously formed in a closed manner around the at least one flow-through areal portion and/or around at least one functional layer.

The module unit is expediently to be joined to the conduit portion by the joining portion.

The module unit is preferably connected to the conduit portion in a positive-locking and/or integrally bonded manner.

In expedient embodiments the combined component and/or the module unit has at least one positive-locking element for a positive engagement with the conduit portion.

No further details have yet been provided in respect of the conduit portion.

In some preferred embodiments the conduit portion is formed from a conduit component.

In particular the one conduit component forming the conduit portion has an opening for inserting the combined component, in particular for inserting the combined component formed as a module unit and/or the module unit forming the combined component.

In particular the combined component is connected to the one conduit component in a positive-locking and/or integrally bonded manner, advantageously is connected fluid-tightly and in particular secured thereto.

For example, the combined component and the conduit portion have positive-locking elements for the positive engagement.

In some advantageous embodiments the conduit portion is formed from at least two conduit components.

In particular the combined component, in particular the combined component formed as a module unit and/or the module unit forming the combined component, is connected to the at least two conduit components in an integrally bonded and/or positive-locking manner, in particular is fluid-tightly connected.

The at least two conduit components advantageously have respective end faces and the combined component is disposed between the end sides.

In particular the frame bears against the end sides of the conduit components and is advantageously connected thereto fluid-sealingly.

For example, a sealing material is provided for the seal between the conduit component or the at least conduit components on the one hand and the combined component, in particular the frame thereof, on the other hand.

In some expedient embodiments additional sealing material is provided for sealing.

In some advantageous embodiments it is provided that the combined component, in particular a joining portion thereof, for example the frame, is welded to the conduit component or the at least two conduit components.

In advantageous embodiments the end sides, in particular end faces thereof, run obliquely to a cross-sectional plane running perpendicular to the fluid guidance direction of the conduit component, wherein for example the obliquely running end sides, in particular the end faces, form an angle with the cross-sectional plane of 10° or greater and/or of 85° or smaller.

In some advantageous embodiments the end sides, in particular the end faces, run at an angle of at most 60°, preferably at most 50°, in particular at most 40° obliquely to the cross-sectional plane.

In some preferred embodiments the end sides, in particular the end faces, run at an angle of at least 40°, for example at least 55°, in particular at least 70° obliquely to the cross-sectional plane.

This is advantageous in particular in order to dispose a combined component with an obliquely running flow-through areal portion and/or with obliquely running functional layer obliquely between the conduit components.

In particular the conduit arrangement comprises a conduit system for a fuel medium at least for supplying fuel medium to the at least one fuel cell unit.

For example, the fuel medium is fed as constituent of an anode fluid mixture by, for example, a supply conduit of the conduit system for the fuel medium to the fuel cell unit, in particular an anode side of the fuel cell unit.

The conduit system for the fuel medium, in particular in the supply conduit, preferably comprises at least one fluid-conveying unit in order to convey the fluid mixture through the conduit system at least in portions.

In particular at least one fluid-conveying unit in the conduit system for the fuel medium is an actively driven fluid-conveying unit, for example a fan or a compressor.

In advantageous embodiments at least one fluid-conveying unit in the conduit system for the fuel medium is a passive fluid-conveying unit, for example a jet pump.

In particular, the conduit system for the fuel medium, for example by means of a discharge conduit, is also configured for the discharge of an anode residual fluid mixture, which in particular in the fuel cell unit contains chemically unreacted fuel medium fractions and/or at least constituents of the supplied anode fluid mixture and/or at least parts of a product medium, from in particular the anode side of the fuel cell unit.

In particularly advantageous embodiments it is provided that a combined component is disposed at least in one conduit portion of the conduit system for the fuel medium.

It is particularly expedient if at least one combined component is disposed in a conduit portion for the supply of fuel medium to the fuel cell unit.

For example, the combined component is disposed between the fluid-conveying unit in the supply conduit and the fuel cell unit, in particular anode side thereof, in relation to the flow of the anode fluid mixture.

In particular, it is advantageous that a liquid input into the fuel cell unit can be at least reduced hereby.

In particular, it is provided that by means of the combined component the supplied fuel medium, in particular as constituent of the anode fluid mixture, is heated by means of the combined component formed as a heat exchanger and thus, for example, increases the efficiency of the fuel cell unit and/or condensing out of liquid, in particular condensing out of water, in the supplied anode fluid mixture is at least reduced.

For example, it is further advantageous that by means of the combined component, in particular the modification material thereof, a liquid phase, in particular water, is partially separated in the anode fluid mixture and/or droplets of the liquid phase are collected and/or size-reduced, for example are dispersed and/or at least partially converted into a gaseous phase, and therefore an input of a liquid phase into the fuel cell unit is at least reduced.

In some expedient embodiments it is provided that a combined component is disposed at least in one conduit portion of the discharge conduit of the conduit system.

For example an anode residual fluid mixture discharged from the fuel cell unit can hereby be treated by means of the combined component, for example temperature-controlled and/or modified, in particular by separation and/or dispersion of a liquid phase in the anode residual fluid mixture, in particular in order to supply chemically unreacted fuel medium fractions in the fuel cell unit to the supply conduit again and thus to the fuel cell unit.

In some advantageous embodiments an anode ring conduit is provided as part of the conduit system for the fuel medium, by means of which anode ring conduit a fuel medium is supplied to the at least one fuel cell unit and chemically unreacted fuel medium fractions in the fuel cell unit can be discharged from the fuel cell unit and supplied again to the fuel cell unit, in particular with further fuel medium fractions.

In particular at least a part of the supply conduit and/or a part of the discharge conduit and/or a connection conduit between the discharge conduit and the supply conduit are a part or parts of the anode ring conduit.

It is particularly expedient if at least one combined component is disposed at least in the anode ring conduit.

In particular, the conduit arrangement comprises a conduit system for an oxidation medium.

The conduit system is expediently configured for the oxidation medium in order to supply an oxidation medium, in particular oxygen, for example as a constituent of a cathode fluid mixture, to the fuel cell unit, in particular to a cathode side thereof, by means of a supply conduit, and in particular to discharge, by means of a drain conduit, an anode residual fluid mixture, which in particular contains chemically unreacted oxidation medium fractions in the fuel cell unit and/or at least constituents of the supplied cathode fluid mixture and/or at least parts of the product medium, from the fuel cell unit, in particular the cathode side thereof.

The conduit system for the oxidation medium, in particular in the supply conduit, preferably comprises at least one fluid-conveying unit in order to convey the fluid mixture through the conduit system at least in portions.

In particular at least one fluid-conveying unit in the conduit system for the oxidation medium is an actively driven fluid-conveying unit, for example a fan or a compressor.

For example, at least one fluid-conveying unit in the conduit system for the oxidation medium is a passive fluid-conveying unit, for example a jet pump.

In particularly advantageous embodiments it is provided that a combined component is disposed at least in one conduit portion of the conduit system for the oxidation medium.

At least one combined component is advantageously disposed in a conduit portion of the supply conduit, for example between a fluid-conveying unit and the fuel cell unit, in particular the cathode side of the fuel cell unit.

In particular, a liquid input into the fuel cell unit can hereby be at least reduced, in particular by an at least partial separation and/or dispersal and/or conversion into a gaseous phase from a liquid phase, in particular from water, for example by the modification material, wherein in particular at least a high moisture in the cathode fluid mixture can be maintained during the dispersal and/or conversion into a gaseous phase.

It is particularly expedient to form the combined component in the supply conduit as an intercooler for cooling the cathode fluid mixture, in particular in order to thus increase the efficiency of the fuel cell unit.

In particular, the conduit arrangement comprises a conduit system for a temperature-control medium of a temperature-control arrangement for the fuel cell unit.

In particular, the temperature-control arrangement for the temperature control is configured, in particular depending on the operating state, for cooling as necessary and/or heating as necessary of the at least one fuel cell unit.

In particular, the conduit system is configured for the temperature-control medium for supplying the temperature-control medium, for example by means of a supply conduit, and in particular is configured for discharging the temperature-control medium from the fuel cell unit, in particular by means of a discharge conduit.

For example, the temperature-control medium comprises an alcohol, in particular a glycol. In particular the temperature-control medium is a mixture of an alcohol, in particular glycol, and water.

In some advantageous embodiments it is provided that at least one combined component is disposed at least in one conduit portion of a conduit system for the temperature-control medium.

For example, at least one combined component is disposed in a conduit portion of the discharge conduit.

It is particularly advantageous if at least one combined component is disposed in a conduit portion of the supply conduit.

In particular, it can hereby be achieved that the supplied temperature-control medium is temperature-controlled at least in a desired temperature range, in particular is cooled, by means of the combined component and/or for example the supply of undesired constituents is at least reduced by the modification by the combined component, for example by an at least partial separation of a constituent and/or by a chemical modification at the modification material.

A further aspect of the invention relates to a vehicle, in particular a vehicle driven at least in part by means of at least one fuel cell unit.

According to one aspect of the invention a fuel cell device having one or preferably more of the above-explained features is disposed in the vehicle, wherein advantageously the vehicle is driven at least in part by the at least one fuel cell unit of the fuel cell device.

The above-explained advantages transfer correspondingly to this aspect of the invention, wherein in a vehicle in particular little installation space is provided, and therefore the installation-space-saving embodiment by means of the combined component is particularly expedient here.

In the foregoing and hereinafter, the wording “at least approximately” in conjunction with a specification is to be understood to mean that technically irrelevant and/or technically induced deviations from the specification are included by the at least approximately stated specification.

For example, deviations of up to +/−10%, preferably of up to +/−5%, in particular of up to +/−1% are included by the at least approximately stated specification. In the case of at least approximately stated directions, for example deviations by up to +/−10°, in particular of up to +/−5° from the stated direction are included.

In the foregoing and hereinafter, features which are described as being provided in particular, for example and/or advantageously and/or preferably or the like are optional features which are not essential for the success according to the invention and represent, for example, further developments associated with advantages.

The above description of solutions according to the invention thus comprises, in particular, the various combinations of features defined by the following consecutively numbered embodiments:
1. A fuel cell device (100) comprising at least one fuel cell unit (110) and a conduit arrangement (112), in particular for a fuel medium and/or for an oxidation medium and/or for a temperature-control medium, wherein there is disposed in the conduit arrangement (112), in particular in a conduit portion (112) thereof, a combined component (220) forming a heat exchanger and a fluid modifier that forms in particular a separator.
2. A fuel cell device (100) in accordance with embodiment 1, wherein the combined component (220) comprises a plurality of pipes (234) for a heat transfer medium that pass through a flow-through areal portion (226) of the combined component (220), and in that in particular the plurality of pipes (234) are part of a temperature-control circuit, wherein in particular the combined component (220) has an inlet port (238) connected to the pipes (234) and an outlet port (239) connected to the pipes.
3. A fuel cell device (100) in accordance with the preceding embodiments, wherein the combined component (220) has a modification material (242) at least in one flow-through areal portion (226) in particular for at least partial formation as a fluid modifier.
4. A fuel cell device (100) in accordance with the preceding embodiments, wherein the modification material (242) in the flow-through areal portion (226) through which a fluid mixture flows during normal operation of the fuel cell device (100) is configured to at least partially separate at least one constituent of the fluid mixture and/or to at least partially disperse a liquid phase in the fluid mixture and/or to at least partially transfer at least one constituent of the fluid mixture from a liquid phase into a gaseous phase and/or to at least partially mix the fluid mixture.
5. A fuel cell device (100) in accordance with the preceding embodiments, wherein the modification material (242) comprises a metal material, in particular is a metal material.
6. A fuel cell device (100) in accordance with the preceding embodiments, wherein the modification material (242) is disposed at least partially in gaps (254) between pipes (234) of the combined component (220).
7. A fuel cell device (100) in accordance with the preceding embodiments, wherein the modification material (242) is disposed bearing at least partially against the pipes (234) of the combined component (220).
8. A fuel cell device (100) in accordance with the preceding embodiments, wherein the modification material (242) is disposed in at least one layer (243) in the flow-through areal portion (226), in particular passes through the flow-through areal portion (226) in at least one layer (243).
9. A fuel cell device (100) in accordance with the preceding embodiment, wherein some of the plurality of pipes (234) are disposed on one side of the layer (243) and some of the plurality of pipes (234) are disposed on an opposite side of the layer (243).
10. A fuel cell device (100) in accordance with the preceding embodiments, wherein fibers (244) provide the modification material (242) at least in part, in particular fibers (244) passing through the flow-through areal portion (226) are formed from the modification material (242).
11. A fuel cell device (100) in accordance with the preceding embodiment, wherein the fibers (244) are elongate, in particular flexible bodies, in particular are wires.
12. A fuel cell device (100) in accordance with the two preceding embodiments, wherein at least some of the fibers (244) and at least some of the plurality of pipes (234) together form a woven fabric.
13. A fuel cell device (100) in particular in accordance with the preceding embodiments, wherein the combined component (220) comprises precisely one functional layer (222) or a plurality of functional layers (222) for a heat transfer and/or a modification of a fluid mixture that is flowing through.
14. A fuel cell device (100) in accordance with the preceding embodiments, wherein the fibers (244) run transverse to the pipes (234) at least in one functional layer (222) and/or at least in one flow-through areal portion (226).
15. A fuel cell device (100) in accordance with the preceding embodiments, wherein a layer (243) with the modification material (242), in particular the fibers (244), at least in one functional layer (222) and/or at least in one flow-through areal portion (226) runs/run alternately on different sides of the pipes (234) in relation to a plane spanned by the pipe extension directions (236) of the pipes (234).
16. A fuel cell device (100) in accordance with the preceding embodiments, wherein at least one functional layer (222) extends obliquely to a fluid guidance direction (262) of the conduit portion (212), and in that in particular the at least one functional layer (222) runs at an angle of 5° or greater and/or at an angle of 80° or smaller obliquely to the fluid guidance direction (262) of the conduit portion (212).
17. A fuel cell device (100) in accordance with the preceding embodiments, wherein pipes (234) of a downstream functional layer (222) are disposed in such a way that a fluid mixture that flows through gaps (254) between pipes (234) of an upstream functional layer (222) flows against these pipes of the downstream functional layer (222).
18. A fuel cell device (100) in accordance with the preceding embodiments, wherein the combined component (220) has flow-through openings (246) in at least one functional layer (222) and/or at least one flow-through areal portion (226), said flow-through openings being surrounded, in particular delimited at least partially by the modification material (242) and/or the pipes (234).
19. A fuel cell device (100) in accordance with the preceding embodiments, wherein at least one flow-through areal portion (226) is surrounded by a frame (256) and/or at least one functional layer (222) comprises a frame (256) and in particular the frame (256) is secured to a conduit wall (262) of the conduit portion (212).
20. A fuel cell device (100) in accordance with the preceding embodiments, wherein the frame (256) is fluid-sealingly connected to the conduit wall (262) of the conduit portion (212).
21. A fuel cell device (100) in accordance with the preceding embodiments, wherein the frame (256) is formed from a plastic, in particular from an elastomer, or in that the frame (256) is formed from a metal material.
22. A fuel cell device (100) in accordance with the preceding embodiments, wherein at least some of the plurality of pipes (234) and/or at least a part of the modification material (242) are connected to the frame (256), in particular are at least partially embedded in the frame (256).
23. A fuel cell device (100) in accordance with the preceding embodiments, wherein the combined component (220) is formed as a module unit, in particular pre-assembled module unit.
24. A module unit which forms a combined component forming a heat exchanger and a fluid modifier, wherein the combined component (220) has in particular one or more of the features of the preceding and following embodiments.
25. A fuel cell device (100) in accordance with the preceding embodiments, wherein the combined component (220) has at least one positive-locking element for a positive engagement with the conduit portion.
26. A fuel cell device (100) in accordance with the preceding embodiments, wherein the combined component (220) and/or the module unit forming the combined component is disposed in a conduit component forming the conduit portion (212) and in particular these are connected to one another in an integrally bonded and/or positive-locking manner.
27. A fuel cell device (100) in accordance with the preceding embodiments, wherein the combined component (220) is disposed between respective end sides (286, 288) of at least two conduit components (282, 284).
28. A fuel cell device (100) in accordance with the preceding embodiments, wherein at least one combined component (220) is disposed at least in one conduit portion (212) of a conduit system (214) for fuel medium of the conduit arrangement (112).
29. A fuel cell device (100) in accordance with the preceding embodiments, wherein at least one combined component (220) is disposed in a conduit portion (212) of a supply conduit (162) of the conduit system (114) for fuel medium.
30. A fuel cell device (100) in accordance with the preceding embodiments, wherein at least one combined component (220) is disposed in a conduit portion (212) of a discharge conduit (176) of the conduit system (114) for fuel medium.
31. A fuel cell device (100) in accordance with the preceding embodiments, wherein at least one combined component is disposed in a conduit portion (212) of an anode ring conduit (188) of the conduit system (114) for fuel medium.
32. A fuel cell device (100) in accordance with the preceding embodiments, wherein at least one combined component (220) is disposed in a conduit portion (212) of a conduit system (116) for oxidation medium of the conduit arrangement (112), in particular is disposed in a conduit portion (212) of a supply conduit (126) of the conduit system (116) for oxidation medium.
33. A fuel cell device (100) in accordance with the preceding embodiments, wherein at least one combined component (220) is disposed in a conduit portion (212) of a conduit system (224) for a temperature-control medium of the conduit arrangement (112), in particular is disposed in a supply conduit (126) of the conduit system (124) for a temperature-control medium, wherein in particular the conduit system for a temperature-control medium is part of a temperature-control arrangement (122) for the at least one fuel cell unit (110), in particular for cooling the fuel cell unit (110).
34. A vehicle with a fuel cell device in accordance with the preceding embodiments.

Further preferred features and, for example, advantages of the invention are the subject of the following description and the graphical depiction of a plurality of exemplary embodiments.

### BRIEF DESCRIPTION OF THE DRAWINGS

In the drawings:

FIG. 1 shows a diagram of a first exemplary embodiment of a fuel cell device;

FIG. 2 shows a partially sectional perspective view of a conduit portion with a combined component;

FIG. 3 shows an exploded view of the conduit portion with the combined component, similarly to in FIG. 2;

FIG. 4 shows a view of a detail of a flow-through areal portion of the combined component;

FIG. 5 shows a view of a detail of an alternative form of a flow-through areal portion;

FIG. 6 shows a schematic view of a detail of the combined component;

FIG. 7 shows a view of a detail of flow-through areal portions of two functional layers;

FIG. 8 shows a view of a detail of a variant of two functional layers;

FIG. 9 shows a view of a detail of a further exemplary embodiment of flow-through areal portions of two functional layers;

FIG. 10 shows a view of a detail of a further variant of flow-through areal portions of two functional layers;

FIG. 11 shows a diagram of a further exemplary embodiment of a fuel cell device;

FIG. 12 shows a diagram of a further exemplary embodiment of a fuel cell device;

FIG. 13 shows a diagram of a further exemplary embodiment of a fuel cell device; and

FIG. 14 shows a view of a detail of a further exemplary embodiment of a flow-through areal portion of a functional layer.

### DETAILED DESCRIPTION OF THE INVENTION

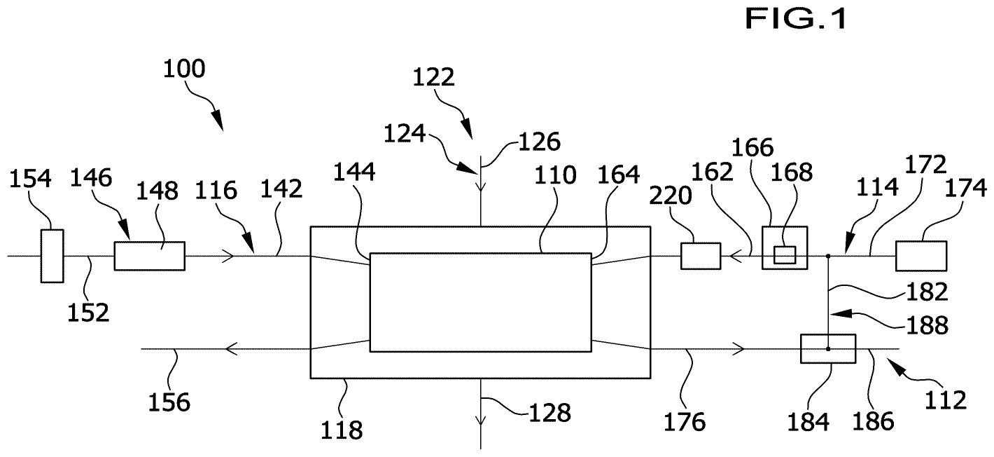

A first exemplary embodiment of a fuel cell device denoted as a whole by 100 comprises at least one fuel cell unit 110 and a conduit arrangement, denoted in its entirety by 112, comprising at least one conduit system 114 for a fuel medium and a conduit system 116 for an oxidation medium, wherein the conduit systems 112, 114 are connected to the at least one fuel cell unit 110, as is shown by way of example in FIG. 1.

The fuel cell unit 110 comprises at least one fuel cell element, preferably a plurality of fuel cell elements, which in particular is/are disposed in a housing 118, wherein the fuel medium and the oxidation medium are chemically converted at least partially into a product medium in the one or more fuel cell elements and in particular electrical energy is provided during this process.

For example, the plurality of fuel elements are disposed one above the other in one or more stacks in a respective stack direction and are connected in series.

For example, a temperature-control device 122 is also provided in order to keep the fuel cell unit 110 in a temperature range admissible for correct operation thereof.

In particular the temperature-control arrangement 122, as part of the conduit arrangement 112, comprises a conduit system 124 for a temperature-control medium which has at least one supply conduit 126 for supplying a temperature-control medium to the fuel cell unit 110 and a discharge conduit 128 for discharging the temperature-control medium from the fuel cell unit 110 and the temperature-control medium is in heat-exchanging contact with the fuel cell unit 110 between the supply conduit 126 and the discharge conduit 128.

The temperature-control arrangement 122 is preferably configured for cooling, as necessary, of the fuel cell unit 110 at least in dependence on the operating state of the fuel cell unit, wherein in particular the supply conduit 126 and the discharge conduit 128 are part of a cooling circuit, and/or for heating, as necessary, of the fuel cell unit 110.

By means of the conduit system 116 for an oxidation medium, the oxidation medium can be supplied to the at least one fuel cell unit 110 and oxidation medium fractions supplied to the at least one fuel cell unit 110 but chemically unreacted therein can be discharged again from the at least one fuel cell unit 110 by means of this conduit system 116.

With normal operation of the fuel cell device 110, by means of this conduit system 116 the oxidation medium is supplied, in particular as a constituent of a fluid mixture, to the at least one fuel cell unit 110 and oxidation medium fractions not reacted in the fuel cell unit 110 are discharged again.

The conduit system 116 for the oxidation medium comprises at least one supply conduit 142, which leads to a cathode side 144 of the fuel cell unit 110 and by which the oxidation medium is supplied to the fuel cell unit 110.

A cathode fluid mixture which comprises the oxidation medium is preferably supplied to the fuel cell unit 110 by means of the supply conduit 142, wherein for example the cathode fluid mixture is a purified air mixture from the surroundings of the fuel cell device 100.

In particular the oxidation medium is oxygen.

In particular a supply unit 146 is arranged in the supply conduit 142, by means of which supply unit the fuel cell unit 110 is supplied with the cathode fluid mixture.

The supply unit 146 preferably comprises a fluid-conveying unit 148.

For example, the supply unit 146 sucks in the fluid mixture via a suction conduit 152, in which there is preferably disposed a filter 154 for purifying the sucked-in fluid mixture, and supplies said fluid mixture through the supply conduit 142 to the fuel cell unit 110.

In addition, the conduit system 116 for the oxidation medium has at least one drain conduit 156, by means of which a cathode residual fluid mixture, which in particular comprises chemically unreacted oxidation medium fractions and/or at least fractions of the product medium created during the chemical process in the fuel cell unit 110 and/or constituents of the supplied cathode fluid mixture, is discharged from the cathode side 144.

By means of the conduit system 114 for the fuel medium, the fuel medium can be supplied to the at least one fuel cell unit 110 and fuel medium fractions supplied to the at least one fuel cell unit but chemically unreacted therein can be discharged again from the at least one fuel cell unit 110.

With normal operation of the fuel cell device 110, by means of this conduit system 114 the fuel medium is supplied, for example as a constituent of an anode fluid mixture, to the at least one fuel cell unit 110 and fuel medium fractions not reacted in the fuel cell unit 110 are discharged again.

The conduit system 114 for the fuel medium comprises at least one supply conduit 162, which leads to an anode side 164 of the fuel cell unit 110 and by which a fuel medium can be supplied to the fuel cell unit 110.

An anode fluid mixture which comprises the fuel medium is preferably supplied to the fuel cell unit 110 by means of the supply conduit 162.

In particular, the fuel medium is hydrogen.

For example the anode fluid mixture comprises water, in particular a minor amount of water.

In particular a supply unit 166 is disposed in the supply conduit 162 and comprises, for example, a fluid-conveying unit 168, for example an actively driven fluid-conveying unit and/or a passive fluid-conveying unit, and is connected via a supply conduit 172 to a reservoir 174 for the fuel medium.

During operation of the fuel cell device, the fuel cell unit 110 is supplied by means of the supply unit 166 with fuel medium from the reservoir 174 via the supply conduit 172 and the supply conduit 162.

In addition, the conduit system 114 for the fuel medium comprises a discharge conduit 176 which leads away from the anode side 164.

By way of this discharge conduit 176, in particular chemically unreacted fuel medium fractions and further fractions of the anode fluid mixture supplied to the anode side 164 and for example also fractions of the product medium created during the chemical reaction are discharged from the anode side 164 as anode residual fluid mixture.

The discharge conduit 176 is preferably connected at least indirectly to the supply conduit 162 via a connection conduit 182, wherein a separation unit 184 is provided at the branching of the connection conduit 182 from the discharge conduit 176, so that unreacted fuel medium fractions are supplied to the supply conduit via the connection conduit 182 and further constituents in the anode residual fluid mixture are discharged via a drain conduit 186.

For example, the connection conduit 182 opens out into the supply conduit 172.

The connection conduit 182 expediently leads to the supply unit 166, more specifically upstream of the fluid-conveying unit 168 in relation to a flow direction, so that the fuel medium fractions supplied by the connection conduit 182 are also conveyed by the fluid-conveying unit 168.

In particular, at least parts of the supply conduit 162 and of the discharge conduit 176 and the connection conduit 182 thus form an anode ring conduit 188 for the fuel medium, by means of which unreacted fuel medium fractions in the anode residual fluid mixture are supplied back to the anode fluid mixture and can be supplied to the fuel cell unit 110.

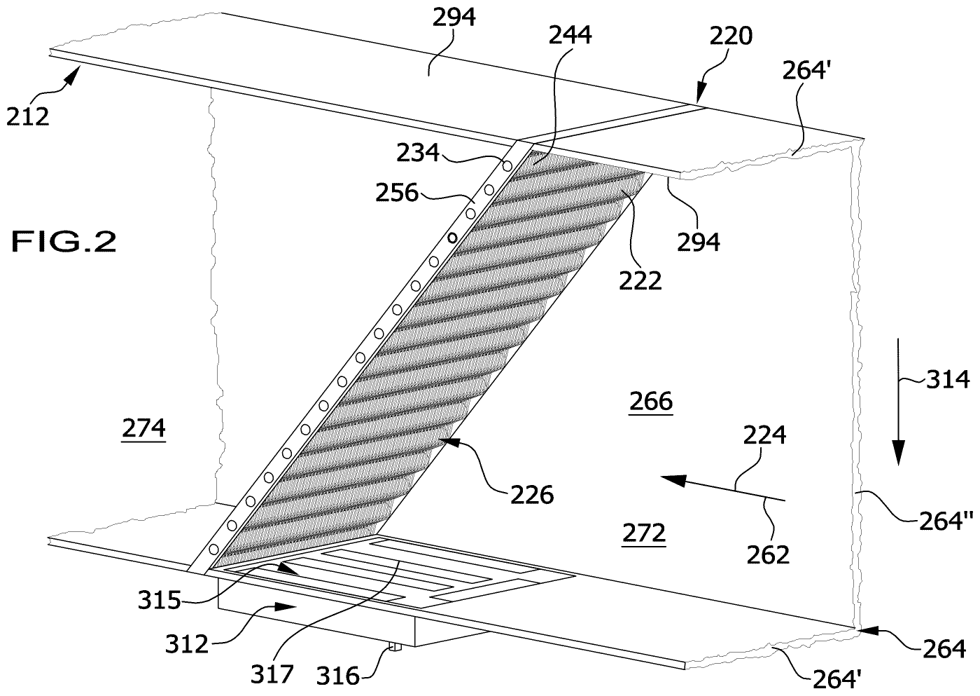

A combined component denoted as whole by 220 is disposed in a conduit portion 212 of the conduit system 114 for the fuel medium and forms a heat exchanger and a fluid modifier, formed in particular as a separator, and is shown by way of example in FIGS. 2 to 6.

In the exemplary embodiment shown by way of example in FIG. 1 the conduit portion 212 with a combined component 220 is a portion of the supply conduit 162 and the combined component 220 is disposed between the supply unit 166 and the fuel cell unit 110 in relation to a flow direction of the anode fluid mixture.

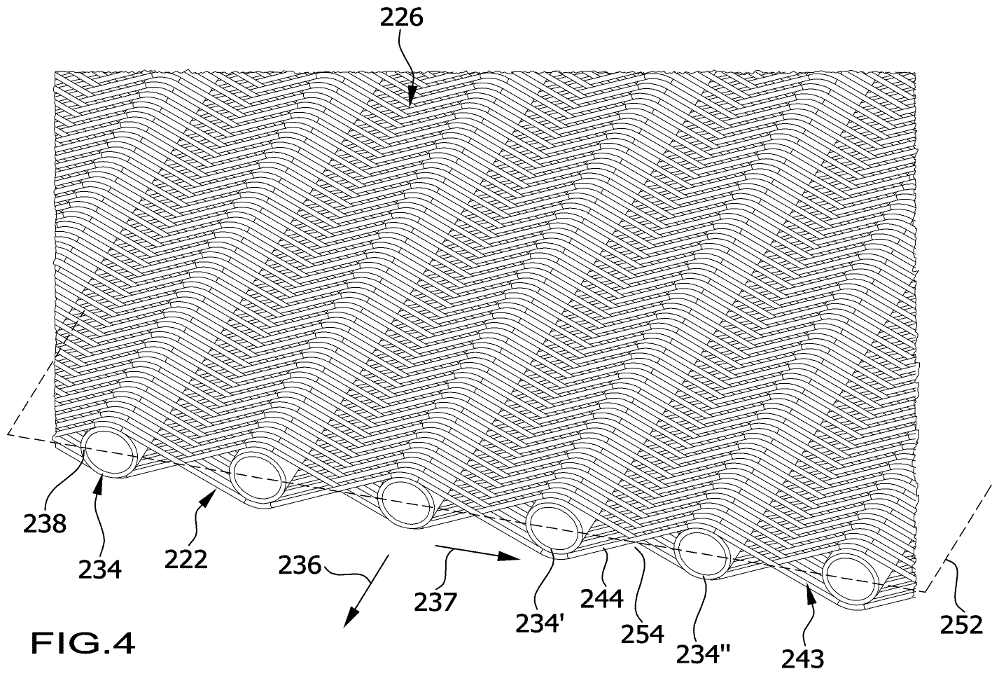

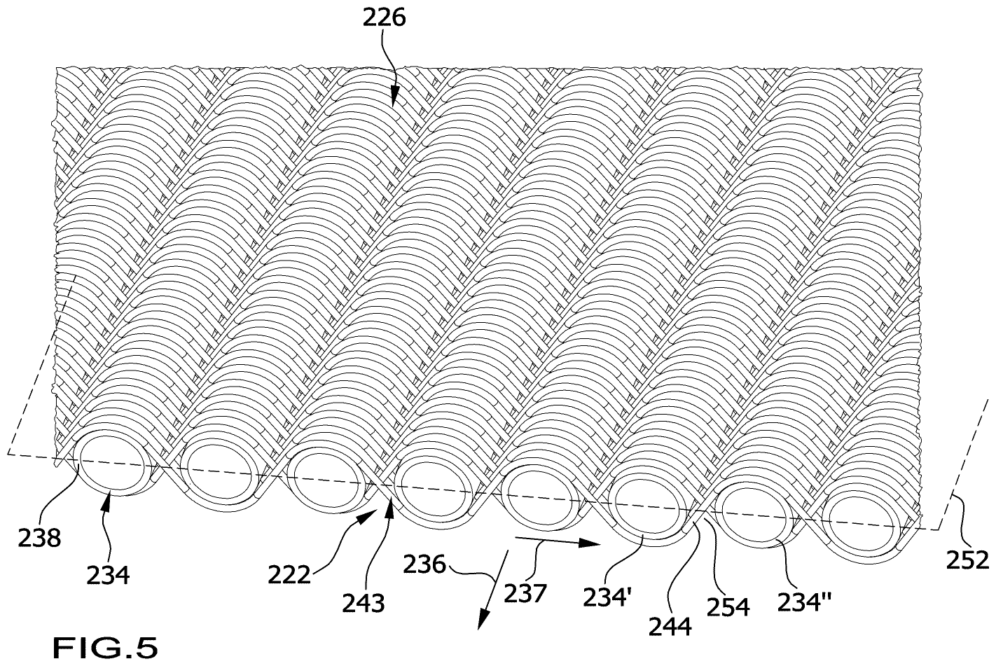

The combined component 220 comprises at least one functional layer 222, which is shown in detail by way of example in different variations in FIGS. 4 and 5 and is disposed in the conduit portion 212 in such a way that the fluid mixture flowing through the conduit portion 212 in a flow direction 224 must flow through a flow-through areal portion 226 of the functional layer 222.

The combined component 220 in this case comprises a pipe system with a plurality of pipes 234, which pass through the flow-through areal portion 226 in the functional layer 122.

In particular, it is provided here that the pipes 234 extend in the flow-through areal portion 226 elongatedly in a respective pipe extension direction 236 through the flow-through areal portion 226.

In particular, the respective pipe extension directions 236 of the plurality of pipes in the flow-through areal portions 226 run at least approximately parallel to one another.

The pipes 234 are preferably disposed adjacently in an arrangement direction 237.

The arrangement direction 237 preferably runs at least approximately perpendicular to the pipe extension direction 236.

The pipes 234 are hollow pipes in this case, with an interior through which a fluid can flow.

The interior of the pipes 234 is separated by a pipe wall 238 from an interior of the conduit portion 212, so that a fluid flowing through the pipes 234 does not pass into the interior of the conduit portion 212 and, correspondingly, a fluid flowing through the conduit portion 212 does not reach the interior of the pipes 234 and therefore these two fluids are not mixed.

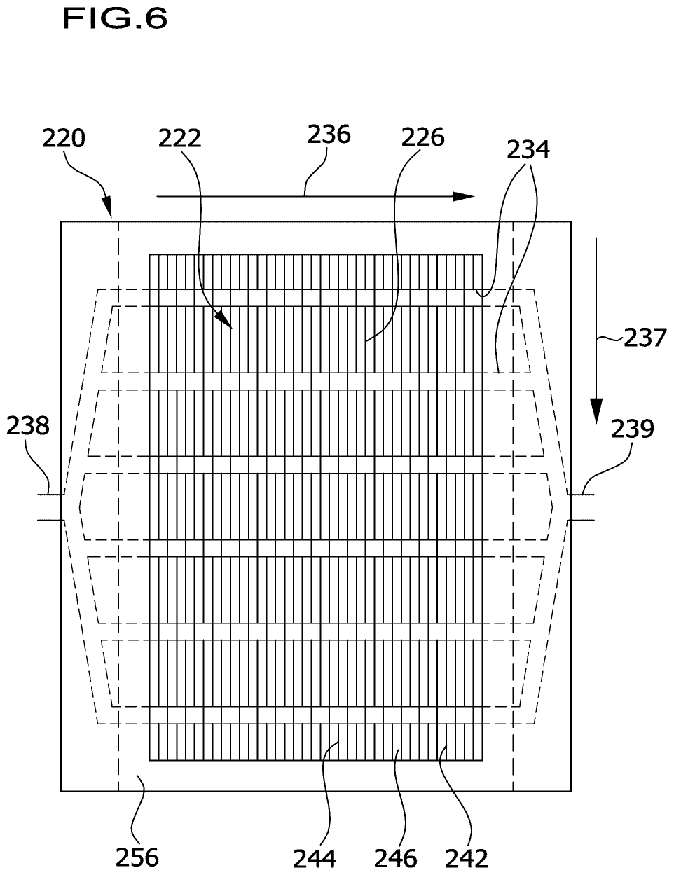

The combined component 220 preferably has an inlet port 238 and an outlet port 239, as shown by way of example in FIG. 6, wherein the pipes 234 are disposed between the inlet port 238 and the outlet port 239 along a fluid path for example having a plurality of strands.

In particular, inlet manifold portions lead on an inlet side form the inlet port 238 to a respective inlet end of the pipes 234, so that a fluid supplied via the inlet port 238 is distributed over the plurality of pipes 234 via the inlet manifold portions and is conducted through said pipes.

In particular, outlet manifold portions lead from a respective outlet end of the pipes 234 to the outlet port 239, so that fluid conducted through the pipes is conducted via the outlet manifold portions to the one outlet port 239.

In particular, in the case of the pipes the inlet end is an end opposite the outlet end.

In variants it is provided, for example, that, at least in the case of some pipes, the outlet end of a pipe is connected to an inlet end of a pipe via a connection conduit portion. In this case a fluid conducted through the one pipe then flows to the closest pipe 234 and through the latter and, depending on the embodiment of the variant, through an outlet manifold portion to the outlet port 239 or to an inlet end of a further pipe.

In particular, the pipes are part of a temperature-control circuit in which the pipes can be connected in particular via the inlet port 238 and the outlet port 239 and in the operating state are connected, wherein a heat transfer medium flows through the temperature-control circuit and thus through the interior of the pipes 234.

The temperature-control circuit comprises a reservoir space for the heat transfer medium and a temperature-control unit for controlling the temperature of the heat transfer medium is preferably disposed between the reservoir space and the pipes so that the heat transfer medium flowing from the reservoir space to the pipes has a temperature adapted for a heat transfer occurring as said medium flows through the pipes.

Furthermore, the pipes are connected to the reservoir space, in particular via the outlet port 239, in such a way that the heat transfer medium flowing off from the pipes flows back into the reservoir space.

In addition, the combined component 220, to at least partially form the fluid modifier, in particular the separator, in the functional layer 222 has a modification material 242, which passes through the interior of the conduit portion 212.

The modification material is thus in contact with a fluid mixture flowing through the conduit portion 212 and in particular the modification material influences the fluid mixture flowing through.

The modification material 242 in this case delimits, for example at least partially together with the pipes 234, a plurality of flow-through openings 246.

In particular, the flow-through openings are smaller than three times a maximally desired size of water droplets in the fluid mixture flowing through the functional layer 222, preferably are smaller than the maximally desired size of the water droplets.

The flow-through openings 246 preferably have a size in the millimeter range.

For example, a maximal extent of the flow-through openings 246 is equal to or less than 50 millimeters and an extent perpendicular to the maximal extent is for example equal to or smaller than 10 millimeters.

The modification material 242 is disposed at least partially between the pipes 234 and in particular is disposed bearing partially against the pipes 234.

In particular the modification material 242 is a material that is a good heat conductor. The modification material 242 is preferably a metal material.

The modification material 242 expediently passes through the functional layer 222 in at least one layer 243 as fibers 244.

The fibers 244 are preferably wires.

In particular the fibers 244 from the modification material 242 run transverse to the pipes 234, in particular at least approximately in the arrangement direction 237, and run past the pipes on different sides bearing against the pipes.

In particular the fibers 244 and the pipes 234 are interwoven, as is shown by way of example in FIGS. 4 and 5.

For example, a fiber 244 at a pipe 234′ runs past a first side in relation to a geometric functional layer plane 252, and at the subsequent pipe 234″ this fiber 244 runs past this pipe on a second side in relation to the functional layer plane 252, so that the fiber runs past the pipes 234 alternately on different sides of the functional layer plane 252.

In variants of the exemplary embodiment not shown in the drawings it is provided that at least some fibers 244 at different pipes 234 run past these pipes on different sides of the functional layer plane 252 in a different way as compared to a constantly alternating manner.

It is preferably provided that, in a gap 254 between each two adjacent pipes 234, at least a plurality of fibers extend from one side of the functional layer plane 252 at one of the two adjacent pipes 234 to the other side of the functional layer plane 252 at the other pipe 234 and thus extend transverse to the functional layer plane 252 between the adjacent pipes.

In particular, at least most of the fibers 244 bear against at least most of the pipes 234 on a respective side.

The functional layer plane 252 is spanned in particular by the pipe extension direction 236 and the arrangement direction 237.

In some variations of the exemplary embodiment the woven fabric from the pipes 234 and the fibers 244 is coarse-meshed, as shown by way of example in FIG. 4.

For example, a distance between two pipes 234 arranged adjacently to one another at least in the arrangement direction 237 is greater than a pipe diameter, wherein this distance is preferably smaller than ten pipe diameters.

For example, the fibers 244 are spaced apart from one another in a direction running at least approximately perpendicular to their running direction, wherein a distance between two adjacent fibers, however, is preferably smaller than ten times the average fiber diameter.

In expedient variants the adjacent fibers bear against one another.

In other variations the woven fabric from the pipes 234 and the fibers 244 is coarse-meshed, as shown by way of example in FIG. 5.

In particular, the pipes 234 are spaced apart from one another closely so that a distance between two adjacent pipes 234 in the arrangement direction 237 is smaller than a pipe diameter.

This distance between two adjacent pipes 234 is in particular, however, greater than a multiple of the average fiber diameter, in particular greater than twice the average fiber diameter, for example greater than ten times the average fiber diameter.

In particular, the fibers 244 are also disposed closely to one another.

For example, a distance of each two adjacent fibers from one another in a direction running at least approximately perpendicular to their running direction is smaller than three times the average fiber diameter.

In particular, adjacent fibers bear against one another.

In further variations of the exemplary embodiment it is provided that, for example, the pipes are arranged closely to one another and the fibers are arranged in a coarse-meshed manner.

In other variations of the exemplary embodiment, the pipes 234 are again arranged in a coarse-meshed manner and the fibers are arranged in a closed-meshed manner relative to one another.

The flow-through areal portion 226 is preferably surrounded by a frame 256, as shown by way of example in FIGS. 2, 3 and 6.

The pipes 234 are embedded with portions in the frame 256 and at least some of the pipes 234 extend through the frame 256 in order to be able to be connected to the temperature-control circuit.

For example, at least some pipes 234 protrude with their inlet ends out from the frame 256 on an inlet side. In particular, a manifold attachment having the inlet port 238 is provided here and has the inlet manifold portions formed in it.

The manifold attachment is fitted onto the inlet side of the frame 256 and the inlet manifold portions are connected to the inlet ends of the pipes 234. In particular the manifold attachment is secured to the frame 256 in particular in an integrally bonded and/or positive-locking manner, for example by welding and/or by soldering and/or by gluing and/or by latching, and the connection between the inlet manifold portions and the inlet ends of the pipes 234 is sealed, for example by a sealing element and/or a sealing compound, wherein preferably the sealing compound can also serve as an integral bonding agent for fastening the manifold attachment to the frame 256.

In particular at least some pipes 234 protrude with their outlet ends on an outlet side to the frame 256, and a manifold attachment having the outlet port 239 is provided, in which manifold attachment the outlet manifold portions are formed.

In particular, the manifold attachment having the outlet port 239 is fitted onto the outlet side of the frame 256 and the outlet manifold portions are connected to the outlet ends of the pipes 234 and preferably are sealed similarly to on the inlet side, and preferably the manifold attachment having the outlet port 239 is secured to the frame 256 similarly to the manifold attachment having the inlet port 238.

In variations of the exemplary embodiment the inlet manifold portions and/or the outlet manifold portions are formed in the frame 256 and the inlet port 238 is formed on an inlet side of the frame 256 and is directly connected fluid-tightly to the inlet ends of the pipes 234 in the frame 256, and/or the outlet port 239 is formed on an outlet side of the frame 256 and is directly connected fluid-tightly to the outlet ends of the pipes 234 in the frame 256.

The fibers 244 are preferably embedded with their ends also in the frame 256.

For example, the frame 256 is formed from a plastic and in particular the pipes 234 and fibers 244 are overmolded by the plastic.

In variants the frame 256 is formed from a metal material.

For example, the pipes 234 are welded or soldered on to the frame 256.

In addition, in the region of the frame, the free regions between the fibers 244 and pipes 234 are closed by a sealing material, preferably by the material of the frame, so that in the region of the frame 256 the functional layer 222 is fluid-tight both in the flow-through direction and transverse thereto.

The functional layer 222 is in particular secured to the conduit portion 212 at an edge thereof, which for example is formed by the frame 256.

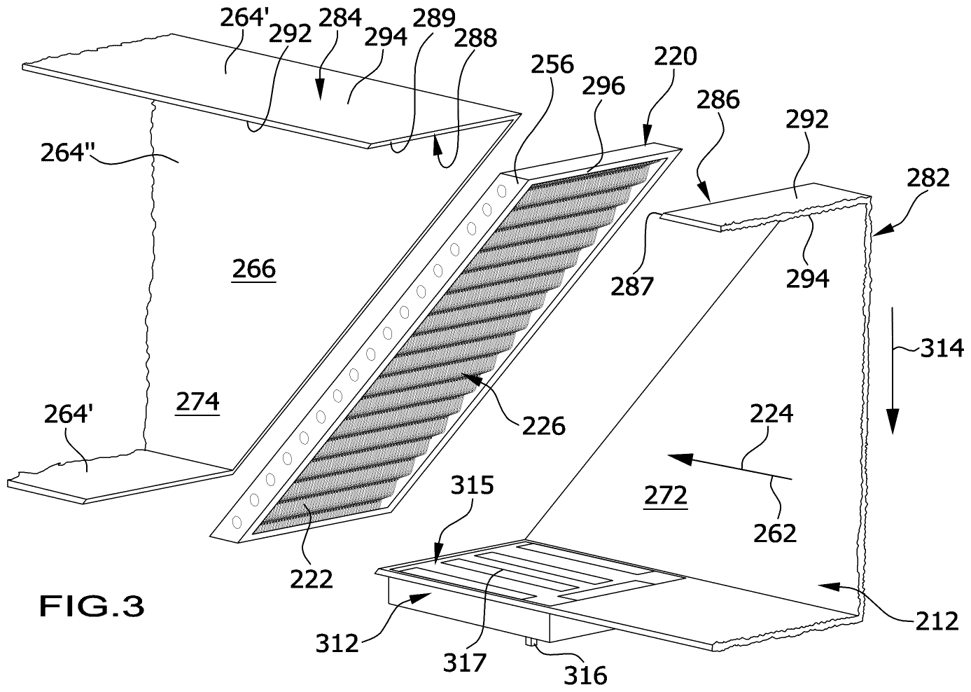

The conduit portion 212 comprises walls 264 extending in a fluid guidance direction 262, which walls delimit an interior 266 of the conduit portion 212 transverse to the fluid guidance direction 262, as shown by way of example in FIGS. 2 and 3.

For example, the conduit portion 212 comprises two transversely running walls 264′, which are spaced apart from one another in a vertical direction, and also two walls 264″, which run in the vertical direction, connect the transversely running walls 264′ and are spaced apart from one another in the transverse direction, and wherein the interior 266 extends in the transverse direction between the two vertically running walls 264″ and in the vertical direction between the two transversely running walls 264′.

In particular the interior 266 runs in the fluid guidance direction 262.

The flow direction 224 runs during normal operation at least approximately in the same direction as the fluid guidance direction 262.

The functional layer 222 is disposed fluid-tightly at its edge on the walls 264 so that the functional layer 222 divides the interior 266 into an upstream portion 272 and into a downstream portion 274 in relation to the fluid guidance direction 262.

In particular, a fluid mixture flowing in the fluid guidance direction 262 flows through the upstream portion 272 to the functional layer 222 and must flow here through the flow-through openings 246 in the flow-through areal portion 226 in order to reach the downstream portion 274.

For example, the functional layer 222, in particular with its frame 256, is welded on to the walls 264 of the conduit portion 212.

It is preferably provided that the conduit portion 212 is formed by two conduit components 282, 284, wherein one of the two conduit components, here the conduit component 282, forms the upstream portion 272 and the other conduit component, here the conduit component 284, forms the downstream portion 274.

In particular the conduit components 282, 284 are formed as shell components.

The conduit components 282, 284 in their corresponding portion 272, 274 form the walls 264 of the conduit portion 212.

The conduit component 282 has an end side 286 that faces the other conduit component 284 and this other conduit component 284 has an end side 288 that faces the conduit component 282, so that the end faces 286, 288 each face one another.

In particular, the end sides 286, 288 have end faces 287, 289 of the corresponding wall portions of the corresponding conduit component 282, 284 forming the walls 264, wherein the end faces 287, 289 connect a wall inner side 292 to a wall outer side 294.

The combined component 220 is arranged in particular with its frame 256 between the two end sides 286, 288 and is connected to these fluid-sealingly.

For example, the interior 266 of the conduit portion 212 is also sealed fluid-tightly to the outside in the transition from the one conduit component 285 to the other conduit component 284 with the functional layer 282 arranged therebetween.

In particular, the frame 256 has a respective joining face 296, 298 on sides that are opposite each other in relation to the fluid guidance direction 262.

The joining faces 296, 298 run peripherally in a closed manner around the flow-through areal portion 226.

The frame 256 bears with one of the joining faces, in this case the joining face 296, against the end face 287 of the upstream conduit component 282 and with the other, opposite joining face, in this case the joining face 298, against the end face 289 of the downstream conduit component 284.

The joining faces 296, 298 bear fluid-sealingly against the respective end face 287, 289.

It is particularly favorable if the frame 256 in the assembled state is pressed against the end sides 286, 288, in particular if it is clamped between the two conduit components 286, 284.

For example, the frame 256 is welded on to the end sides 286, 288.

In variations of the exemplary embodiment, an additional sealing material is alternatively or additionally provided between the frame 256 and the conduit components 282, 284, in particular the end sides 286, 288 thereof.

Preferably, the combined component 220 is formed as a pre-assembled module unit, which in particular comprises the at least one flow-through areal portion and/or the at least one functional layer 222, the pipes 234 and the modification material 242 and advantageously the inlet port 238 and the outlet port 239 and in particular a joining portion comprising, for example, the joining faces 296, 298.

Advantageously, the combined component 220 can thus be completely manufactured in a pre-assembly operation and, during the manufacture of the fuel cell device, the combined component 220 formed as a pre-assembled module unit merely has to be inserted into the conduit portion 212, secured thereto and sealed, and the pipe system of the pipes 234 merely has to be connected to the temperature-control circuit via the inlet port 238 and the outlet port 239.

In advantageous variants of the exemplary embodiment, the conduit portion 212, in which the combined component 220 formed in particular as a module unit is mounted, is formed by a conduit component which is, for example, a shell component, wherein the conduit component will be provided or is provided with an opening through which the combined component is inserted into the interior 266 of the conduit portion 212 and is secured in particular to the walls 264 thereof.

For example, the conduit portion 212 and the combined component 220 have positive-locking elements, for example at least one groove and one tongue, for holding and/or securing the combined component 220 in the conduit portion 212 with positive engagement.

Alternatively or additionally, the combined component 220 is connected for example to the walls 264 of the conduit portion 212 at a joining portion in an integrally bonded manner, for example by welding and/or soldering and/or gluing, which joining portion in particular runs peripherally in a closed manner around the flow-through areal portion 226 and/or the functional layer 222 and is formed, for example, by the frame 256 and/or the manifold attachments.

In particular, the combined component 220 is sealed with respect to the walls 264 of the conduit portion 212, wherein the sealing is achieved, for example, by means of the integral bond and/or by an additional sealing material applied.

Preferably, incidentally, the conduit portion 212 and the arrangement of the combined component 220 are provided, where applicable, as explained above and below.

The functional layer 222 is preferably disposed obliquely to the fluid guidance direction 262 in the conduit portion 212.

Thus, the area of the flow-through areal portion 226 is larger than a cross-sectional area of the interior 266 perpendicular to the fluid guidance direction 262. For example, the area of the flow-through areal portion 226 is at least 15% larger than the cross-sectional area and/or at most twice the cross-sectional area of the interior 266.

In particular, the arrangement direction 237, in which the pipes 234 of the functional layer 222 are arranged one behind the other, runs obliquely to the fluid guidance direction 262, for example the arrangement direction runs at an angle of 5° or greater and/or 80° or less to the fluid guidance direction 262.

In particular, the fibers 244 run at least on average, i.e. in particular averaged over the changes in direction necessary for running past different sides of the pipes 234, at an angle to the direction of fluid flow 262, in particular from one of the walls 264 to an opposite wall, their direction of flow including, for example, an angle of 5° or greater and/or of 80° and/or less with the fluid guidance direction 262.

In particular, a collection tank 312 is also provided in the conduit portion in the vicinity of the combined component 220.

The collection tank 312 is disposed at the bottom of the combined component 220 in relation to a force of gravity direction 314.

The collection tank 312 is preferably disposed in the upstream portion 272.

The collection tank 312 comprises a collection space, in particular for fluid separated at the combined component 220, in particular for a separated liquid, for example water.

Preferably, the collection space opens upward in relation to the force of gravity direction 314 into the interior 266 of the conduit portion 212.

Preferably, the oblique functional layer 222 extends above the opening of the collection tank 312 in relation to the force of gravity direction 314, wherein in particular a projection of the functional layer 222 in the force of gravity direction 314 downward at least largely covers the opening of the collection tank 312.

Preferably, the collection tank 312 comprises a separation element 315, which for example is sometimes also called a baffle, wherein the separation element 315 separates the collection space of the collection tank 312 from the interior 266 through which the fluid mixture flows. In particular, the separation element 315 has openings 317 which connect the interior 266 to the collection space.

For example, the separation element is a perforated plate.

Advantageously, the separation element 315 reduces at least the risk or prevents the fluid flowing through the interior 266 from taking up again liquid, in particular water, that has collected in the collection space.

Preferably, the separation element 315 reduces at least the risk or prevents liquid, in particular water, from sloshing out of the collection space into the interior 266, for example due to vibrations.

Fluid separated from the combined component, in particular a separated liquid, passes through the openings 317 into the collection space of the collection tank 312.

Preferably, the collection tank 312 comprises an outflow 318 through which fluid, for example water, received by the collection tank can be discharged.

For example, the water received by the collection tank 312 is supplied to a humidifier which humidifies the cathode fluid mixture and/or anode fluid mixture supplied to the fuel cell unit.

In particular a structure and an operating principle of the fuel cell device 100 is briefly summarized as follows.

In the at least one fuel cell unit 110, a fuel medium and an oxidation medium are chemically reacted, wherein at least one product medium is formed and electrical energy is provided by the fuel cell unit.

For the supply of the oxidation medium, the fuel cell device 100 comprises the conduit system 116 with which a cathode fluid mixture comprising the oxidation medium is supplied to the fuel cell unit 110 and oxidation medium which has not been consumed, i.e., which has not been chemically reacted in the fuel cell unit 110, and further constituents of the cathode residual fluid mixture are led away again from the fuel cell unit 110.

In addition, for the fuel medium, the fuel cell device 100 comprises the conduit system 114, by means of which an anode fluid mixture comprising the fuel medium is supplied to the fuel cell unit 100 and fuel medium which has not been consumed, i.e., which has not been chemically reacted in the fuel cell unit 110, and further constituents of the anode residual fluid mixture are led away again from the fuel cell unit.

Preferably, a connection conduit 182 is also provided, by means of which fuel medium not consumed by the discharged anode residual fluid mixture is fed back to the anode fluid mixture supplied to the fuel cell unit 110.

The combined component 220 is disposed in the conduit arrangement 112 comprising the conduit systems 114, 116, 124, in particular in the supply conduit 172, by means of which the anode fluid mixture comprising the fuel medium is supplied to the fuel cell unit 110.

In this case, the combined component 220 forms a heat exchanger and a fluid modifier, in particular one that chemically and/or physically modifies the fluid mixture flowing through the conduit portion 212 in which the combined component 220 is disposed.

Preferably, the combined component 220 is formed as a separator with respect to the modification of the fluid mixture, wherein in particular liquid water in the fluid mixture is separated by the fluid modifier.

Alternatively or additionally, the fluid modifier is configured to collect water droplets in the fluid mixture flowing through that in particular exceed a maximally tolerated size, and in particular to separate and/or finely disperse them and/or at least partially transfer them into the gaseous phase, so that the fluid mixture flowing through the combined component 220 still has a sufficient relative humidity.

In particular a normal functioning of the fuel cell unit 110 is hereby enables and the efficiency of said unit is increased.

Preferably, the fluid modifier reduces the amount of water droplets contained in the fluid mixture flowing through the combined component 220 and, in particular by separation and/or dispersal and/or transfer into a gaseous phase, removes water droplets that are larger than a tolerable size.

For example, by mixing the fluid mixture flowing through the combined component 220 and/or by the dispersal and/or transfer of water droplets into a gaseous phase, a drying out of a stack in the fuel cell unit is avoided or at least the risk of drying out is reduced.

The operating principle of the combined component 220 as a heat exchanger also enables the fluid mixture flowing through it to be brought at least close to a desired temperature, for example to a target temperature range, before being supplied to the fuel cell unit, and thus preferably increases the efficiency of the fuel cell unit.

Preferably, heating the fluid mixture with the heat exchanger at least supports an at least partial transfer of a constituent, in particular water, in the fluid mixture from a liquid phase into a gaseous phase.

In particular, the anode fluid mixture is heated in the combined component 220 disposed between the fluid-conveying unit 168 and the fuel cell unit 110.

In particular, the combined component 220 has the functional layer 222, in which the pipes 234 are disposed, through which a heat transfer medium flows for the heat exchange, and in which the modification material 242 is preferably disposed as fibers 244 for modifying the fluid mixture.

The pipes 234 and the modification material 242 form flow-through openings 246, which in particular have a size in the millimeter range, wherein the fluid mixture flowing through the conduit portion 212 must flow from the upstream portion 272 through the flow-through openings 246 into the flow-through areal portion 226 of the functional layer 222 in order to reach the downstream portion 274 of the conduit portion 212.

When the fluid mixture flows through the flow-through areal portion 226, the fluid mixture flowing through the flow-through areal portion 226 comes into contact with the pipes 234 and the modification material 242 and, in particular, a heat exchange takes place between the fluid mixture and the heat transfer medium and the fluid mixture is modified, in particular physically and/or chemically, at least by the contact with the modification material 242.

In particular, the modification material 242 is at least partially disposed between the pipes 234 so that the fluid mixture that must flow through between the pipes 234 can be effectively modified.

In particular, the fluid mixture flows against the modification material 242 and is deflected, for example, in a different flow direction at least locally in the flow-through areal portion 226.

Preferably, at least one constituent of the fluid mixture, in particular water, is at least partially separated from the fluid mixture by the interaction of the modification material 242 with the fluid mixture, and/or excessively large droplets of a liquid in the fluid mixture, in particular water droplets, are collected by the modification material 242 and, for example, the liquid droplets are separated from the fluid mixture and/or finely dispersed and/or converted into a gaseous phase. Preferably, the interaction of the modification material 242 with the fluid mixture also results in good mixing of the fluid mixture.

In particular, the interaction of the modification material with the fluid mixture contributes to good heat transfer.

Furthermore, it is expedient if the modification material 242 also at least partially bears against the pipes 234 and thus the heat exchange is increased if the modification material 242 has good heat conductivity, since a surface over which a heat exchange can take place between the fluid mixture and the heat transfer medium flowing through the pipes is significantly increased.

In particular, the fibers 244 formed from the modification material 242 are interwoven with the pipes 234.

In particular, this provides a large surface of the functional layer 222 and fine flow-through openings 246 for good heat exchange and preferably good mixing of the fluid mixture flowing through the functional layer 222.

The functional layer 222 of the combined component 220 is preferably disposed obliquely to the fluid guidance direction 262 in the conduit portion 212.

In particular, this increases the functional area of the flow-through areal portion 226, so that heat exchange is increased and the modification of the fluid mixture, in particular the separation of at least one constituent and/or the mixing of the fluid mixture, is improved.

In addition, the oblique position can be used to influence, in particular reduce, a pressure drop at the functional layer 222 in a targeted manner.

In particular, the pipes 234 and the modification material 242, preferably in the form of fibers 244, are held on the periphery of the flow-through areal portion 226 by a frame 256, in which they are embedded in particular, and wherein the frame 256 is, for example, molded onto them.

The functional layer 222 with the pipes 234 and the modification material 242 is secured in particular fluid-tightly to walls 264 of the conduit portion 212, in particular the frame 256 is secured to the walls 264.

Preferably, the conduit portion 212 has at least two conduit components 282, 284, which have respective end sides 286, 288 and the end sides 286, 288 face each other.

A part of the functional layer 222, in particular the frame 256, is disposed fluid-tightly between the end sides 286, 288, in particular clamped between the conduit components 284.

In preferred variants, the conduit portion 212 is formed from a conduit component in which the combined component 220 is arranged fluid-tightly.

The combined component is advantageously formed as a pre-assembled module unit.

Preferably, a collection tank 312, in particular for a liquid separated from the fluid mixture by the combined component 220, for example water, is also disposed in the conduit portion 212 at the combined component 220.

In other exemplary embodiments, those elements and features which are at least substantially the same and/or which fulfill at least substantially the same basic functions as in the first or a further exemplary embodiment are provided with the same reference numerals, wherein, in particular if particular reference is to be made to the configuration in an exemplary embodiment, a letter designating this exemplary embodiment is added to these reference numerals as a suffix. Unless otherwise or additionally explained below, reference is made in full to the explanations in conjunction with the above and the other exemplary embodiments explained below with regard to the description of such elements and/or features.

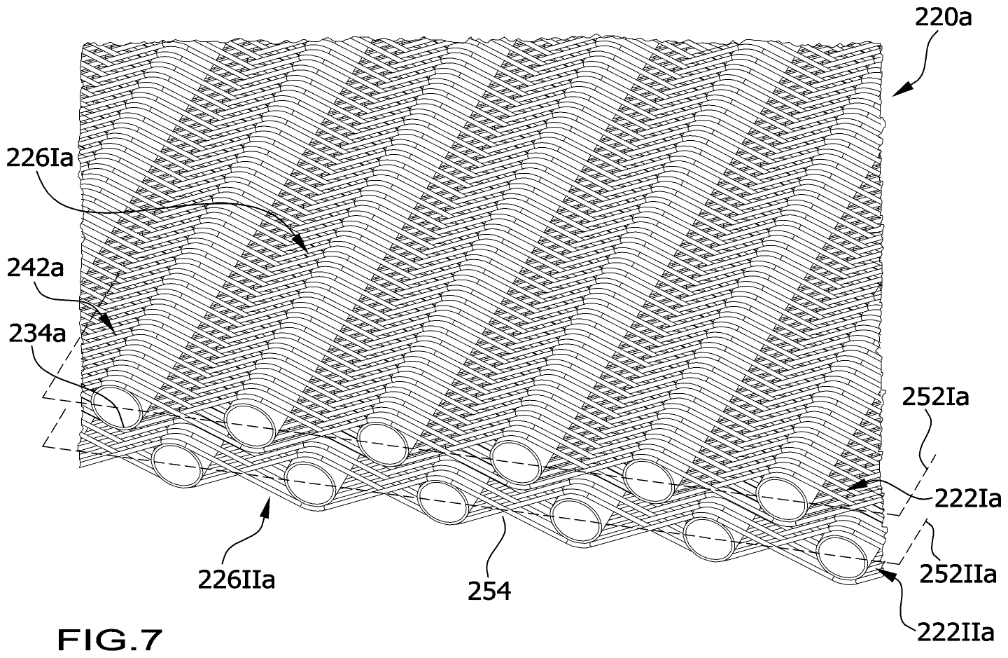

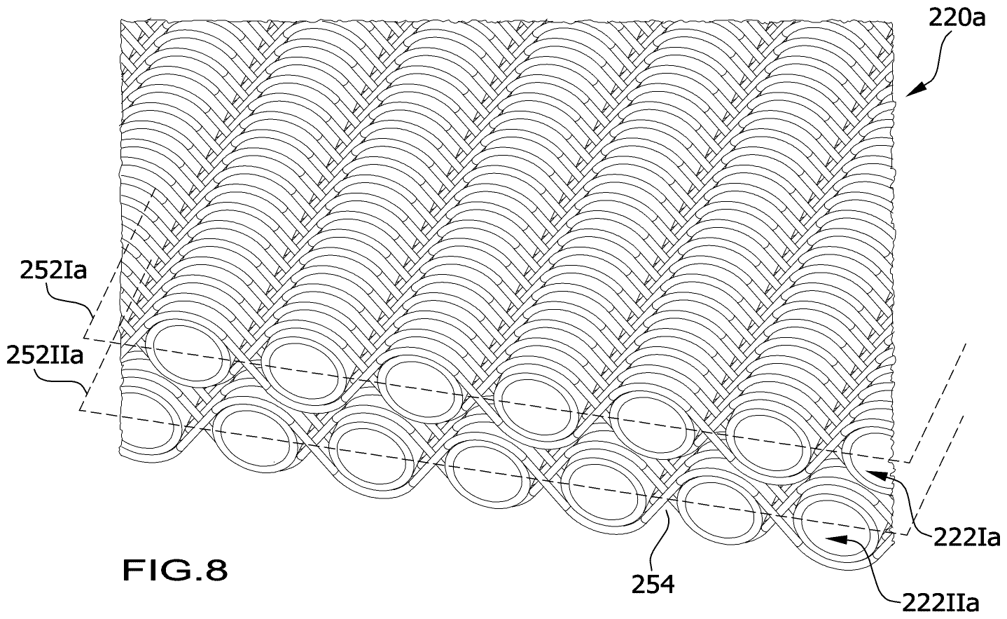

In a second exemplary embodiment, which is shown by way of example in a detail in variations in FIGS. 7 and 8, a fuel cell device 100 comprises a fuel cell unit 110 and a conduit arrangement 112 with a conduit system 114 for a fuel medium and a conduit system 116 for an oxidation medium and, for example, also a temperature-control arrangement 122, which are preferably formed as in the first exemplary embodiment.

A combined component 220a is disposed in a conduit portion 212 of the conduit arrangement 112 and comprises a plurality of, for example two, functional layers 222Ia, 222IIa.

The functional layers 222Ia, 222IIa in particular each comprise pipes 234a of a pipe system and a modification material 242a, which is disposed at least partially between the pipes 234a and in particular also partially adjacent to the pipes 234a.

The modification material 242a is preferably provided in the form of fibers 244.

In particular, the functional layers 222Ia, 222IIa each have either a frame 256 or a common frame 256, which surrounds corresponding flow-through areal portions 226Ia, 226IIa of the functional layers 222Ia, 222IIa peripherally and in particular holds the pipes 234a and the modification material 242a.

For example, the conduit portion 212a is formed from at least two conduit components 282, 284, which each have at least one end side 286, 288, which face each other.

Preferably, the one frame 256 or the frames 256 are disposed between the end sides 286, 288 and are connected thereto fluid-tightly.

For example, the combined component 220a is clamped between the at least two conduit components 282, 284, particularly in the region of the one frame 256 or in the region of the plurality of frames 256.

With regard to further advantageous forms in particular of the conduit arrangement 112 with the conduit systems 114, 116, of the conduit portion 212, and of the combined component 220a with the plurality of functional layers 222a and in particular the form of the individual functional layers 222Ia, 222IIa, reference is made to the embodiment in conjunction with the first exemplary embodiment in order to avoid repetition.

Preferably, the plurality of functional layers 222Ia, 222IIa are disposed at least approximately parallel to one another, wherein in particular their respective geometric functional layer planes 252Ia, 252IIa run at least approximately parallel to one another.

In particular, in this exemplary embodiment, the pipe extension directions 236 of the pipes 234a run at least approximately parallel to one another in the plurality of functional layers, here in the functional layers 222Ia, 222IIa.

Preferably, the pipes 234a of a functional layer 222Ia are disposed offset relative to the pipes 234 of a further functional layer 222IIa, in particular in a direction running at least approximately perpendicular to their pipe extension direction 236.

In particular, the pipes 234 in adjacent functional layers 222Ia, 222IIa are disposed offset to one another in such a way that the fluid flowing between two pipes 234 adjacent in a functional layer 222Ia contacts a pipe 234 of this functional layer 222IIa in the subsequent functional layer 222IIa.

For example, opposite a respective gap 254 between two adjacent pipes 234a of the one functional layer 222Ia in a direction running at least approximately perpendicular to the functional layer plane 252Ia of the functional layer 222Ia, there is disposed a pipe 234 of the functional layer 222IIa disposed directly behind.

Furthermore, in particular correspondingly behind a pipe 234 of the one functional layer, here the functional layer 222Ia, there is disposed a gap between two pipes 234a of the functional layer disposed behind, here the functional layer 222IIa.

For example, the form of the fuel cell device 100a is otherwise as in the first exemplary embodiment described.

In particular, an operating principle and, for example, advantages of this exemplary embodiment are briefly summarized as follows.

Due to the multiple functional layers 222Ia, 222IIa, a total effective area of the combined component 222a, which is composed of the areas of the flow-through areal portion 226Ia, 226IIa of the multiple functional layers 222Ia, 222IIa, is increased and thus advantageously a heat transfer is increased and/or the modification of the fluid mixture, in particular a mixing thereof and/or a separation of at least one constituent, is increased.

It is further advantageous that, after flowing through a gap 254 between two pipes 234a in a functional position in which modification material 242a has preferably already acted on the fluid mixture, for example in a heat-transferring and/or mixing and/or separating manner, the fluid mixture flowing through flows against at least one pipe 234a of a further functional position and the flow direction of the fluid mixture is thereby changed.

The deflection of the fluid mixture in the plurality of functional layers in particular improves the operating principle of the combined component 220, in particular with regard to heat transfer and/or modification of the fluid mixture, preferably mixing and/or separation.

In particular, the operating principle of the fuel cell device 100a is otherwise at least substantially the same as in the exemplary embodiments explained above and/or below.

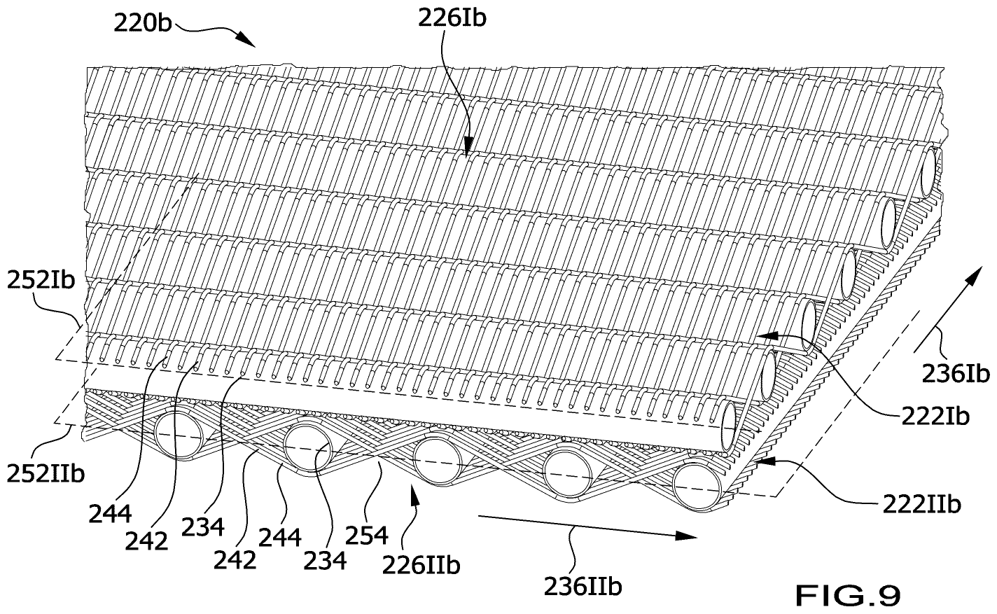

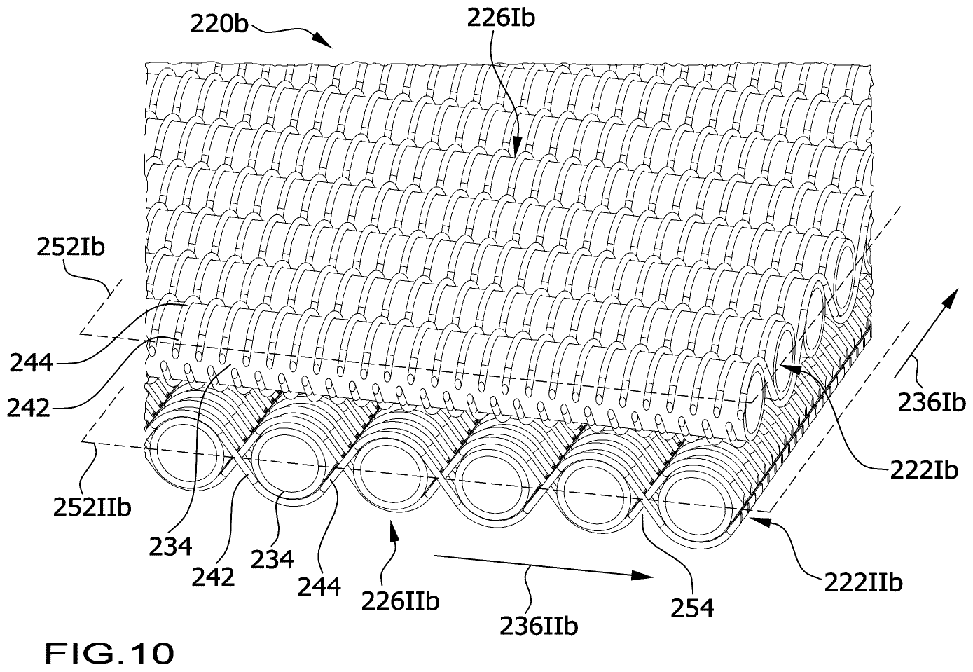

A detail of a third exemplary embodiment is shown by way of example in variations in FIGS. 9 and 10.

Also in this exemplary embodiment, a fuel cell device 100 comprises at least one fuel cell unit and a conduit arrangement with a conduit system for a fuel medium and a conduit system for an oxidation medium and, for example, a temperature-control arrangement, preferably with at least one or more features as in one of the exemplary embodiments explained above.

A combined component 220b with a plurality of functional layers, here with at least two functional layers 2221b, 222IIb, is disposed in a conduit portion 212b of the conduit arrangement.

The functional layers 2221b, 222IIb comprise pipes 234 of a pipe system and a modification material 242, which is disposed at least partially between the pipes 234 and preferably partially bearing against the pipes 234 and is provided in particular in the form of fibers 244.

In this exemplary embodiment it is provided that the pipe extension directions 236 of the pipes 234 in one functional layer 222b run at least approximately perpendicular to the pipe extension directions 236 of the pipes 234 in another functional layer 222b.

For example, the pipe extension directions 2361b of the pipes 2341b of the one functional layer 222Ib run at least approximately perpendicular to the pipe extension directions 236IIb of the pipes 234IIb in the further functional layer 222IIb.

In particular, the pipes 234 within a functional layer 222b run at least approximately in a same pipe extension direction 236b and, for example, an averaged pipe extension direction within a functional layer runs at least approximately perpendicular to the averaged pipe extension direction in another functional layer.

In a variation of the exemplary embodiment not shown in the drawings, the pipe extension directions 236b of the pipes 234 in one functional layer 222b run obliquely to the pipe extension directions 236b of the pipes 234b in another functional layer 222b, wherein again preferably the pipes 234b within a functional layer 222b extend at least approximately in the same pipe extension direction 236b and an averaged pipe extension direction of the respective functional layers 222b is used for the comparison of the pipe extension directions 236b between two functional layers 222b.

Thus, in this exemplary embodiment, it is advantageously achieved that the fluid mixture flowing through the combined component 220, in particular through the flow-through areal portions 2261b, 226IIb of the functional layers 2221b, 222IIb, first flows through a gap 254 between pipes 234b of a functional layer 222b and then at least partially flows against a pipe 234b of a subsequent functional layer 222b and is deflected thereby, and other parts of the fluid mixture flowing through flows through a gap 254 of the pipes 234b of the subsequent functional layer 222b, wherein modification material 242 is preferably disposed in the gaps 254.

Preferably, the operating principle of the combined component 220, in particular with regard to the heat transfer and/or the modification of the fluid mixture, for example with regard to the mixing thereof and/or the separation of at least one constituent, can hereby in turn be selectively manipulated and adjusted.

In particular, the fibers 244 and pipes 234 of a respective functional layer 222b are interwoven, as explained in conjunction with the first exemplary embodiment.

Here, for example, a coarse-meshed or close-meshed arrangement of the pipes 234 and/or fibers 244 is provided.

In some variants, the plurality of functional layers 2221b, 222IIb are formed substantially in the same way and in other variants are formed differently, for example with regard to the close-meshed or coarse-meshed arrangement of the pipes 234 and/or fibers 244.

Incidentally, a structure of the fuel cell device and an operating principle thereof is, at least with respect to some features, preferably at least substantially as in one of the exemplary embodiments described above and/or below.

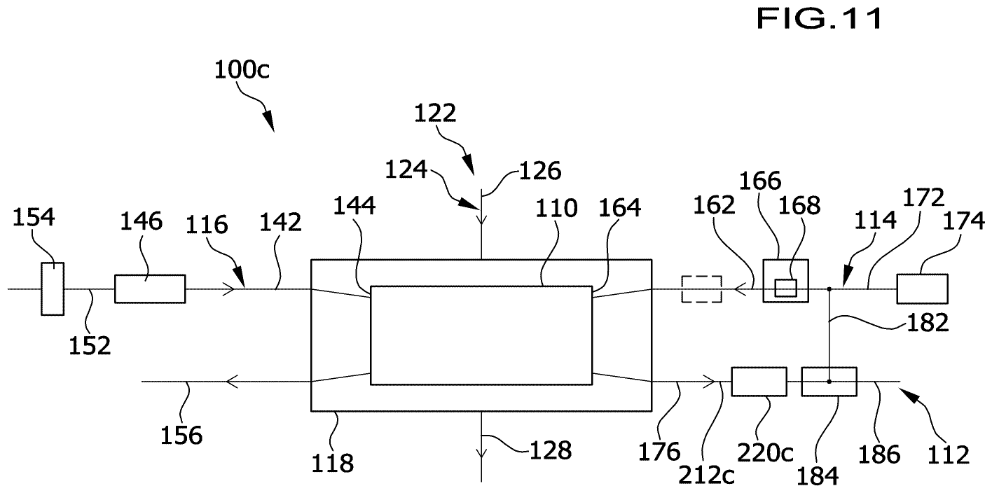

A further exemplary embodiment of a fuel cell device 100c, which is shown by way of example in FIG. 11, comprises a fuel cell unit 110 and a conduit arrangement 112 with a conduit system 114 for a fuel medium and a conduit system 116 for an oxidation medium.

For example, the fuel cell device 100 additionally comprises a temperature-control arrangement 122.

In particular, the conduit system 114 for the fuel medium comprises a supply conduit 162, by means of which the fuel medium, in particular a fluid mixture comprising the fuel medium, is guided to the anode side 164 of the fuel cell unit 110, and a discharge conduit 176, by means of which fuel medium that is not consumed, i.e., in particular fuel medium that has not been chemically reacted, and in particular further constituents of the fluid mixture supplied, is fed away again from the anode side 164 of the fuel cell unit 110.

Preferably, a connection conduit 182 is also provided between the return conduit 176c and the supply conduit 162, so that discharged fuel medium that has not been consumed can be fed back to the anode side 164 through the supply conduit 162, in particular by feeding it to the supplied fluid mixture.

In this exemplary embodiment, a combined component 220c is disposed in a conduit portion 212c of the discharge conduit 176c of the conduit system 114 for the fuel medium.

The combined component 220c has one or more functional layers 222, through the flow-through areal portion 226 or through the flow-through areal portions 226 of which the discharged fuel medium that has not been consumed, in particular the fluid mixture comprising the discharged fuel medium that has not been consumed, must flow when flowing through the discharge conduit 176.

For example, the combined component 220c can be used to modify the discharged fluid mixture in such a way that undesired constituents, for example liquid product water, are at least partially separated from the fluid mixture and/or finely dispersed, and/or at least one constituent, in particular water, is at least partially converted from a liquid phase into a gaseous phase, for example in order to thus prepare the fluid mixture for further use, for example recirculation via the connection conduit 182 into the supply conduit 165.

In addition, the combined component 220c preferably brings the discharged fuel medium that has not been consumed, in particular the fluid mixture comprising this fuel medium that has not been consumed, into a desired temperature range, in particular heats it, in order to, for example, compensate for a cooling as it passes through the fuel cell unit 110c and, in particular, to prepare it for further use, for example recirculation via the connection conduit 182 into the supply conduit 162c.

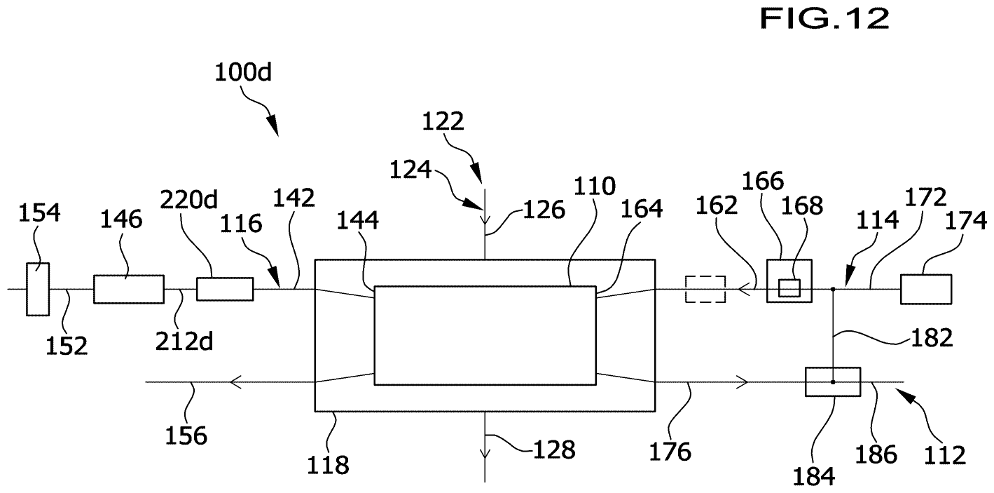

A further exemplary embodiment of a fuel cell device 100d, which is shown by way of example in FIG. 12, comprises a fuel cell unit 110d and a conduit arrangement 112d with a conduit system 114d for a fuel medium and a conduit system 116d for an oxidation medium.

For example, the fuel cell device 100 also comprises a temperature-control arrangement 122.

The conduit system 116 for the oxidation medium comprises, in particular, a supply conduit 142, which guides oxidation medium, in particular a fluid mixture comprising the oxidation medium, to the cathode side 174 of the fuel cell unit 110, and a drain conduit 156, by means of which oxidation medium that is not consumed, i.e., in particular oxidation medium that has not been chemically reacted, and in particular further constituents of the fluid mixture supplied, is/are fed away again from the cathode side 174.

In this fuel cell device 100d it is provided that a combined component 220d is disposed in a conduit portion 212d of the supply conduit 142 of the conduit system 116 for the oxidation medium.

Preferably, the combined component 222d is disposed downstream of a fluid-conveying unit 148 of a supply unit 146 in the supply conduit 142 with respect to the flow of the cathode fluid mixture.

The combined component 220d comprises one functional layer or a plurality of functional layers 222, in particular as explained above for the different exemplary embodiments.

In particular, this means that the fluid mixture supplied to the cathode side 174 is brought into a desired temperature range suitable for the fuel cell unit 110d for operation and/or the fluid mixture is modified, in particular mixed and/or undesired constituents are at least partially separated and/or at least one constituent is at least partially converted from a liquid phase into a gaseous phase.

Preferably, the combined component 220d is formed as an air intercooler with regard to its embodiment as a heat exchanger and cools the cathode fluid mixture flowing through it.

In particular, this increases the efficiency of the fuel cell unit 110.

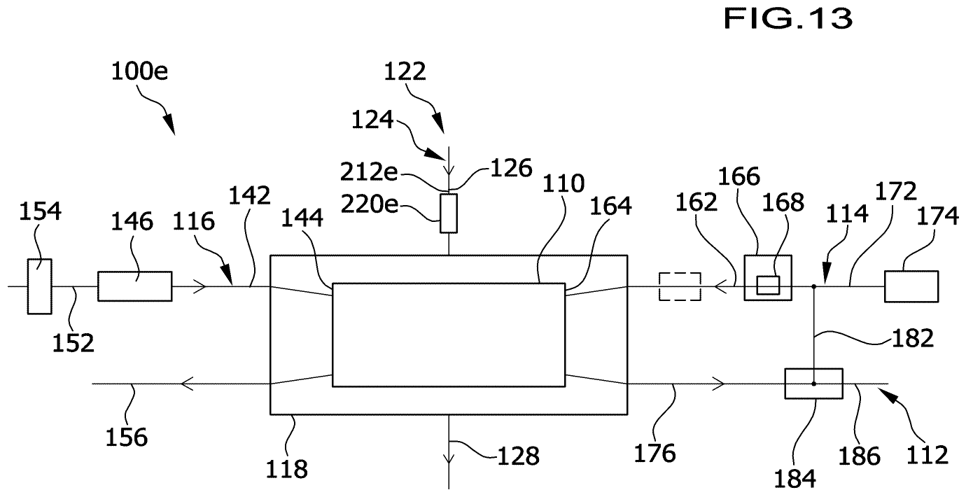

In a further exemplary embodiment, which is shown by way of example in FIG. 13, a fuel cell device 100e comprises a fuel cell unit 110 and a conduit arrangement 112 with a conduit system 114 for a fuel medium and a conduit system 116 for an oxidation medium, and also a conduit system 124 for a temperature-control medium of a temperature-control arrangement 122.

In this exemplary embodiment a combined component 220e is preferably disposed in the suppl conduit 126 in the conduit system 124 of the temperature-control arrangement 122.

In particular, the temperature-control arrangement 122 is configured to cool the at least one fuel cell unit 110 and the temperature-control medium is cooled by means of the combined component 220e and preferably introduced into the housing 118.

In particular, the combined components 220c, 220d, 220e of the three exemplary embodiments explained above with their one or more functional layers and the respective conduit portion 212c, 212d, 212e, in which these combined components 220c, 220d are disposed, are formed as in one of the exemplary embodiments explained above and/or below and/or have combinations of features of these exemplary embodiments, so that, in order to avoid repetitions, reference is made in full to the corresponding explanations.

Furthermore, an embodiment of the fuel cell devices 110c, 110d, 110e, in particular with regard to the conduit arrangement 112 with the conduit systems 114, 116, 124 and, for example, the temperature-control arrangement 122, is advantageously formed as in one of the exemplary embodiments explained above or below and/or these have combinations of features of the exemplary embodiments explained above and below, so that reference is made in full to the preceding and following explanations in order to avoid repetitions.

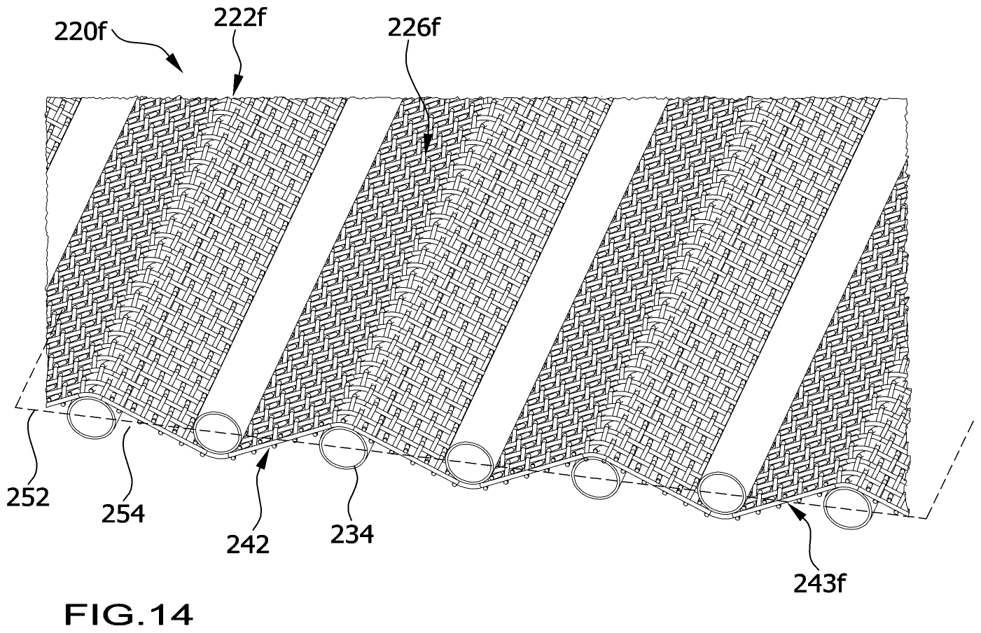

In a further exemplary embodiment, a combined component 220f, which is shown in detail by way of example in FIG. 14, is provided in a fuel cell device 100 with at least one fuel cell unit 110 and a conduit arrangement 112, wherein the conduit arrangement 112 has a conduit system 114 for a fuel medium, a conduit system 116 for an oxidation medium, and in particular a conduit system 124 for a temperature-control medium of a temperature-control arrangement 122.

In particular, the fuel cell device 100 with the at least one fuel cell unit 110 and the conduit arrangement 112 comprising the conduit systems is formed as in one of the exemplary embodiments explained above and/or has a combination of the features explained in conjunction with the exemplary embodiments explained above, and therefore reference is made in full to the above explanations in order to avoid repetitions.

The combined component 220f is disposed in a conduit portion 212 of the conduit arrangement 112, in particular in a conduit portion 212 of one of the conduit systems 114, 116, 124 as explained in conjunction with the exemplary embodiments explained above, and therefore reference is made in full to the above explanations.

The combined component 220f comprises at least one functional layer 222f, which comprises pipes 234 and a modification material 242, which is disposed in particular in gaps 254 between the pipes 234 and in particular also at least partially bearing against the pipes 234 in the functional layer 222f.

In this exemplary embodiment, a layer 243f of the modification material 242 is formed as a braid, in particular a metallic braid.

The braid passes through the functional layer 222 at least in the flow-through areal portion 226f and runs alternately on opposite sides of a functional layer plane 252f past the pipes 234 and thus also passes through the gaps 254 between the pipes 234, in which the braid extends obliquely to the geometric functional layer plane 252 from one side to the other side.

In variations it is provided that the braid runs past a plurality of adjacent pipes on one side and then runs to the opposite side in a gap 254 and runs past a plurality of pipes 234 on this side.

In particular, the braid is formed from fibers, preferably wires, wherein at least a first group of fibers run transversely, for example at least approximately perpendicularly, to fibers of a second group and thus the fibers of different groups intersect one another.

In variants of the exemplary embodiment, the layer 243f formed from the modification material 242 is, for example, a perforated film which accordingly passes through at least the flow-through areal portion 226f and extends past the pipes 234 on different sides thereof and through the gaps 254 between the pipes 234.

Preferably, incidentally, the combined component 220f is formed at least substantially as in one of the exemplary embodiments explained above, or has a combination of features of the exemplary embodiments explained above, and therefore reference is made to the above explanations, in particular with regard to the embodiment with one functional layer plane or a plurality of functional layer planes and a frame of the combined component 220f, as well as its installation in a conduit portion of the conduit arrangement 112, for example in one of the conduit systems for the fuel medium and/or oxidation medium and/or temperature-control medium, and in particular a fluid-tight securing in the conduit portion, for example between end faces of two conduit components, and further advantageous embodiments.

In further exemplary embodiments not shown separately in the drawings, a fuel cell device 100 has a plurality of combined components 220 in its conduit arrangement 112, in particular in the supply conduit and/or the discharge conduit of the conduit system for the fuel medium and/or in one conduit or a plurality of conduits, in particular in the supply conduit, of the conduit system for the oxidation medium and/or in the conduit system of the temperature-control arrangement, in particular in its supply conduit.

In these exemplary embodiments, in particular incidentally the form of the conduit arrangement with the conduit systems and the form of the combined components with one or more functional layers is at least substantially the same as in one of the exemplary embodiments explained above, and these in particular have features and/or combinations of features of the exemplary embodiments explained above, so that reference is made in full to the above explanations.

### LIST OF REFERENCE NUMERALS

### Without the Suffix Denoting the Exemplary Embodiment

1. 100 fuel cell device
2. 110 fuel cell unit
3. 112 conduit arrangement
4. 114 conduit system for fuel medium
5. 116 conduit system for oxidation medium
6. 118 housing
7. 122 temperature-control device
8. 124 conduit system for temperature-control medium
9. 126 feed conduit
10. 128 discharge conduit
11. 142 supply conduit
12. 144 cathode side
13. 146 supply unit
14. 148 fluid-conveying unit
15. 152 suction conduit
16. 154 filter
17. 165 drain conduit
18. 162 supply conduit
19. 164 anode side
20. 166 supply unit
21. 168 fluid-conveying unit
22. 172 supply conduit
23. 174 reservoir
24. 176 discharge conduit
25. 182 connection conduit
26. 184 separation unit
27. 186 drain conduit
28. 188 ring conduit
29. 212 conduit portion
30. 220 combined component
31. 222 functional layer
32. 224 flow direction
33. 226 flow-through areal portion
34. 234 pipes
35. 236 pipe extension direction
36. 237 arrangement direction
37. 238 inlet port
38. 239 outlet port
39. 242 modification material
40. 243 layer
41. 244 fibers
42. 246 flow-through openings
43. 252 functional layer plane
44. 254 gap between pipes
45. 256 frame
46. 262 fluid guidance direction
47. 262 walls
48. 266 interior
49. 268 wall inner side
50. 272 upstream portion
51. 274 downstream portion
52. 282 conduit component
53. 284 conduit component
54. 286 end side
55. 287 end face
56. 288 end side
57. 289 end face
58. 292 wall inner side
59. 294 wall outer side
60. 296 joining face
61. 298 joining face
62. 312 collection tank
63. 314 force of gravity direction
64. 315 separation element
65. 317 openings
66. 318 outflow

What is claimed:

1. A fuel cell device comprising at least one fuel cell unit and a conduit arrangement for at least one of a fuel medium and/or an oxidation medium and/or a temperature-control medium, wherein there is disposed in at least one conduit portion of the conduit arrangement a combined component forming a heat exchanger and a fluid modifier the fluid modifier forming a separator.

2. The fuel cell device in accordance with claim 1, wherein the combined component comprises a plurality of pipes for a heat transfer medium that pass through a flow-through areal portion of the combined component.

3. The fuel cell device in accordance with claim 1, wherein the combined component has a modification material at least in one flow-through areal portion and wherein the modification material in the flow-through areal portion through which a fluid mixture flows during normal operation of the fuel cell device is configured to at least one of the following to at least partially separate at least one constituent of the fluid mixture and/or to at least partially disperse a liquid phase in the fluid mixture and/or to at least partially transfer at least one constituent of the fluid mixture from a liquid phase into a gaseous phase and/or to at least partially mix the fluid mixture.

4. The fuel cell device in accordance with claim 1, wherein a modification material of the fluid modifier comprises a metal material.

5. The fuel cell device in accordance with claim 1, wherein a modification material of the fluid modifier is disposed at least partially in gaps between pipes of the combined component.

6. The fuel cell device in accordance with claim 1, wherein a modification material of the fluid modifier is disposed bearing at least partially against pipes of the combined component.

7. The fuel cell device in accordance with claim 1, wherein a modification material of the fluid modifier is disposed in at least one layer in a flow-through areal portion and some pipes of a plurality of pipes are disposed on one side of the at least one layer and some pipes of the plurality of pipes are disposed on an opposite side of the at least one layer.

8. The fuel cell device in accordance with claim 1, wherein fibers provide a modification material of the fluid modifier at least in part.

9. The fuel cell device in accordance with claim 8, wherein at least some fibers and at least some of a plurality of pipes together form a woven fabric.

10. A fuel cell device comprising at least one fuel cell unit and a conduit arrangement for at least one of a fuel medium and/or an oxidation medium and/or a temperature-control medium, wherein there is disposed in at least one conduit portion of the conduit arrangement a combined component which comprises at least one functional layer for a heat transfer and a modification of a fluid mixture that is flowing through.

11. The fuel cell device in accordance with claim 10, wherein fibers for a fluid modification run transverse to pipes in the at least one functional layer.

12. The fuel cell device in accordance with claim 10, wherein a layer with a modification material for the modification of a fluid mixture runs in the at least one functional layer alternately on different sides of pipes in relation to a plane spanned by a pipe extension direction of the pipes.

13. The fuel cell device in accordance with claim 10, wherein the at least one functional layer extends obliquely to a fluid guidance direction of the conduit portion.

14. The fuel cell device in accordance with claim 10, wherein pipes of a downstream functional layer are disposed in such a way that a fluid mixture that flows through gaps between pipes of an upstream functional layer flows against these pipes of the downstream functional layer.

15. The fuel cell device in accordance with claim 1, wherein at least one flow-through areal portion is surrounded by a frame and the frame is secured to a conduit wall of the conduit portion.

16. The fuel cell device in accordance with claim 1, wherein at least one of some of a plurality of pipes for the heat exchanger and/or at least a part of a modification material of the fluid modifier is at least partially embedded in the frame.

17. The fuel cell device in accordance with claim 1, wherein the combined component is formed as a pre-assembled module unit.

18. The fuel cell device in accordance with claim 1, wherein the combined component has at least one positive-locking element for a positive engagement with the conduit portion.

19. The fuel cell device in accordance with claim 1, wherein at least one combined component is disposed in at least one of a conduit portion of a conduit system for fuel medium of the conduit arrangement and/or a conduit portion of a supply conduit of the conduit system for fuel medium and/or a conduit portion of a discharge conduit of the conduit system for fuel medium and/or a conduit portion of an anode ring conduit of the conduit system for fuel medium and/or a conduit portion of a conduit system for oxidation medium of the conduit arrangement.

20. A vehicle, the vehicle comprising the fuel cell device in accordance with claim 1.
